(19) United States
(12) Patent Application Publication
(10) Pub. No.: US 2026/0071745 A1
(43) Pub. Date: Mar. 12, 2026

(54) LIGHTING DEVICES AND OTHER ACCESSORIES HAVING AN INTEGRATED AND RETRACTABLE CHARGING CORD

(71) Applicant: LB Marketing, Inc., Peachtree Corners, GA (US)

(72) Inventors: Douglas R. Kaye, Peachtree Corners, GA (US); Jack Grembowitz, Peachtree Corners (GA)

(21) Appl. No.: 19/325,171

(22) Filed: Sep. 10, 2025

Related U.S. Application Data
(60) Provisional application No. 63/693,146, filed on Sep. 10, 2024.

(51) Int. Cl. F21V 27/00; F21L 4/00; F21L 4/08; F21V 21/084

(52) U.S. Cl. CPC F21V 27/005; F21L 4/005; F21L 4/085; F21V 21/084

(57) ABSTRACT

The present disclosure provides a lighting device including a housing, a light source disposed within the housing, a power source disposed within the housing and electrically coupled to the light source, and a retractable charge cord assembly integrated within the housing. The retractable charge cord assembly includes a charge cord, a connector coupled to an end of the charge cord, and a retraction mechanism configured to extend and retract the charge cord. The retraction mechanism may include a wheel around which the charge cord is wound and a spring mechanism coupled to the wheel to facilitate automatic retraction of the charge cord. The connector may be configured to nest within a portion of the housing when the charge cord is fully retracted. The lighting device may include a cover movably coupled to the housing to conceal the connector when in a closed position.

### CROSS-REFERENCE TO RELATED APPLICATIONS

This application claims priority to U.S. Patent Application Ser. No. 63/693,146 filed Sep. 10, 2024, which is incorporated herein by reference.

### TECHNICAL FIELD

The present disclosure relates to lighting devices and related electronics, and more particularly to lighting devices and accessories thereof featuring an integrated retractable charging cord.

### BACKGROUND

Portable lighting devices, such as flashlights, headlamps, lanterns, and work lights, have become essential tools for both professional and personal use. These devices provide illumination in various settings, from outdoor adventures to emergency situations. As technology has advanced, consumers have come to expect more functionality and convenience from their portable lighting devices. One of the key challenges in the design and use of portable lighting devices is power management. Traditional battery-powered devices often require frequent battery replacements or manual recharging, which can be inconvenient and potentially leave users without light when they need it most. Rechargeable batteries have addressed some of these issues, but they still require users to remember to charge their devices and often necessitate carrying separate charging cables or docks.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a top view of an example flashlight according to various aspects and embodiments of the present disclosure.

FIG. 1B illustrates a side view of the flashlight shown in FIG. 1A according to various aspects and embodiments of the present disclosure.

FIG. 1C illustrates a perspective view of the flashlight shown in FIG. 1A according to various aspects and embodiments of the present disclosure.

FIG. 1D illustrates a rear end view of the flashlight shown in FIG. 1A with a tailcap component removed from view according to various aspects and embodiments of the present disclosure.

FIG. 1E illustrates a cutaway perspective view of a rear end region on the flashlight shown in FIG. 1A according to various aspects and embodiments of the present disclosure.

FIG. 2A illustrates a perspective view of another example flashlight according to various aspects and embodiments of the present disclosure.

FIG. 2B illustrates another perspective view of the flashlight shown in FIG. 2A according to various aspects and embodiments of the present disclosure.

FIG. 2C illustrates another perspective view of the flashlight shown in FIG. 2A according to various aspects and embodiments of the present disclosure.

FIG. 2D illustrates a side view of the flashlight shown in FIG. 2A with certain components removed from view according to various aspects and embodiments of the present disclosure.

FIG. 3A illustrates a perspective view of another example flashlight according to various aspects and embodiments of the present disclosure.

FIG. 3B illustrates a top view of the flashlight shown in FIG. 3A according to various aspects and embodiments of the present disclosure.

FIG. 3C illustrates a cross-sectional top view of the flashlight designated A-A in FIG. 3B according to various aspects and embodiments of the present disclosure.

FIG. 3D illustrates another top view of the flashlight shown in FIG. 3A with certain components removed according to various aspects and embodiments of the present disclosure.

FIG. 3E illustrates a side view of the flashlight shown in FIG. 3A with certain components removed according to various aspects and embodiments of the present disclosure.

FIG. 4A illustrates a perspective view of an example headlamp battery pack according to various aspects and embodiments of the present disclosure.

FIG. 4B illustrates another perspective view of the headlamp battery pack shown in FIG. 4A with a cover component in an open position according to various aspects and embodiments of the present disclosure.

FIG. 4C illustrates another perspective view of the headlamp battery pack shown in FIG. 4A with a cover component in an open position according to various aspects and embodiments of the present disclosure.

FIG. 4D illustrates a cross-sectional front view of the headlamp battery pack shown in FIG. 4A according to various aspects and embodiments of the present disclosure.

FIG. 4E illustrates a cross-sectional side view of the headlamp battery pack shown in FIG. 4A according to various aspects and embodiments of the present disclosure.

FIG. 5A illustrates a perspective view of an example headlamp according to various aspects and embodiments of the present disclosure.

FIG. 5B illustrates another perspective view of the headlamp shown in FIG. 5A with a cover component in an open position according to various aspects and embodiments of the present disclosure.

FIG. 5C illustrates another perspective view of the headlamp shown in FIG. 5A with a cover component in an open position according to various aspects and embodiments of the present disclosure.

FIG. 5D illustrates a cross-sectional front view of the headlamp shown in FIG. 5A according to various aspects and embodiments of the present disclosure.

FIG. 5E illustrates a cross-sectional side view of the headlamp shown in FIG. 5A according to various aspects and embodiments of the present disclosure.

FIG. 5F illustrates example retractable charge cord assembly extension states of the headlamp shown in FIG. 5A according to various aspects and embodiments of the present disclosure.

FIG. 6A illustrates an exploded perspective view of another example headlamp battery pack with certain components removed from view according to various aspects and embodiments of the present disclosure.

FIG. 6B illustrates a front view of the headlamp battery pack shown in FIG. 6A according to various aspects and embodiments of the present disclosure.

FIG. 6C illustrates a cross-sectional front view of the headlamp battery pack shown in FIG. 6A according to various aspects and embodiments of the present disclosure.

FIG. 6D illustrates a cross-sectional side view of the headlamp battery pack shown in FIG. 6A according to various aspects and embodiments of the present disclosure.

FIG. 7A illustrates an exploded perspective view of an example worklight according to various aspects and embodiments of the present disclosure.

FIG. 7B illustrates a rear view of the worklight shown in FIG. 7A according to various aspects and embodiments of the present disclosure.

FIG. 7C illustrates a side view of the worklight shown in FIG. 7A according to various aspects and embodiments of the present disclosure.

FIG. 7D illustrates a cross-sectional rear view of the worklight designated B-B in FIG. 7C according to various aspects and embodiments of the present disclosure.

FIG. 7E illustrates an exploded perspective view of an example retraction mechanism on the worklight shown in FIG. 7A according to various aspects and embodiments of the present disclosure.

FIG. 8A illustrates a perspective view of another example worklight according to various aspects and embodiments of the present disclosure.

FIG. 8B illustrates another perspective view of the worklight shown in FIG. 8A with a cover component in an open position according to various aspects and embodiments of the present disclosure.

FIG. 8C illustrates another perspective view of the worklight shown in FIG. 8A with a cover component in an open position according to various aspects and embodiments of the present disclosure.

FIG. 8D illustrates a cross-sectional front view of the worklight shown in FIG. 8A according to various aspects and embodiments of the present disclosure.

FIG. 8E illustrates a cross-sectional perspective view of the worklight shown in FIG. 8A according to various aspects and embodiments of the present disclosure.

FIG. 8F illustrates example retractable charge cord assembly extension states of the worklight shown in FIG. 8A according to various aspects and embodiments of the present disclosure.

FIG. 9A illustrates a front perspective view of another example worklight according to various aspects and embodiments of the present disclosure.

FIG. 9B illustrates another front perspective view of the worklight shown in FIG. 9A according to various aspects and embodiments of the present disclosure.

FIG. 9C illustrates another front perspective view of the worklight shown in FIG. 9A with a cover component in an open position according to various aspects and embodiments of the present disclosure.

FIG. 9D illustrates another front perspective view of the worklight shown in FIG. 9A with a cover component in an open position according to various aspects and embodiments of the present disclosure.

FIG. 9E illustrates another front perspective view of the worklight shown in FIG. 9A with a cover component in an open position according to various aspects and embodiments of the present disclosure.

FIG. 9F illustrates a rear perspective view of the worklight shown in FIG. 9A according to various aspects and embodiments of the present disclosure.

FIG. 9G illustrates another rear perspective view of the worklight shown in FIG. 9A according to various aspects and embodiments of the present disclosure.

FIG. 9H illustrates another rear perspective view of the worklight shown in FIG. 9A with a cover component in an open position according to various aspects and embodiments of the present disclosure.

FIG. 9I illustrates another rear perspective view of the worklight shown in FIG. 9A with a cover component in an open position according to various aspects and embodiments of the present disclosure.

FIG. 9J illustrates another rear perspective view of the worklight shown in FIG. 9A with a cover component in an open position according to various aspects and embodiments of the present disclosure.

FIG. 10A illustrates a perspective view of an example lantern according to various aspects and embodiments of the present disclosure.

FIG. 10B illustrates a side view of the lantern shown in FIG. 10A according to various aspects and embodiments of the present disclosure.

FIG. 10C illustrates a cross-sectional top view of the lantern designated C-C in FIG. 10B according to various aspects and embodiments of the present disclosure.

FIG. 10D illustrates another cross-sectional top view of the lantern designated C-C in FIG. 10B with certain components removed from view according to various aspects and embodiments of the present disclosure.

FIG. 10E illustrates another cross-sectional top view of the lantern designated C-C in FIG. 10B with certain components removed from view according to various aspects and embodiments of the present disclosure.

FIG. 11A illustrates a perspective view of another example lantern according to various aspects and embodiments of the present disclosure.

FIG. 11B illustrates another perspective view of the lantern shown in FIG. 11A with a cover component in an open position according to various aspects and embodiments of the present disclosure.

FIG. 11C illustrates another perspective view of the lantern shown in FIG. 11A with a cover component in an open position according to various aspects and embodiments of the present disclosure.

FIG. 11D illustrates another perspective view of the lantern shown in FIG. 11A with a cover component in an open position according to various aspects and embodiments of the present disclosure.

FIG. 11E illustrates a cross-sectional front view of the lantern shown in FIG. 11A according to various aspects and embodiments of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The design of portable lighting devices must balance multiple factors, including size, weight, durability, and functionality. Incorporating additional features, such as charging capabilities, can be done in a way that does not significantly compromise the primary purpose of the device or its portability. Furthermore, these devices are often used in challenging environments where exposure to water, dust, and physical impacts is common, necessitating robust and protective designs.

As the reliance on portable electronic devices continues to grow, there is an increasing need for lighting devices that can not only illuminate but also serve as power sources for other devices. This dual functionality can be particularly valuable in remote locations or emergency situations where access to traditional power sources may be limited. The evolution of portable lighting devices reflects a broader trend in consumer electronics towards multi-functional, self-contained units that offer greater convenience and versatility. However, integrating these additional features while maintaining the core functionality, durability, and user-friendliness of lighting devices presents ongoing challenges for designers and manufacturers in the field.

The present disclosure provides lighting devices that integrate a retractable charge cord assembly within or on their housing. These devices span a range of portable lighting products, including but not limited to flashlights, headlamps, lanterns, and worklights. The integrated retractable charge cord assembly includes a charge cord, a connector coupled to an end of the charge cord, and a retraction mechanism configured to extend and retract the charge cord into one of a multitude of discrete extension lengths. This design offers a significant advantage over traditional designs by eliminating the need for separate charging cables or docking stations, thereby enhancing the convenience and portability of the lighting devices. The lighting devices can also serve as power sources for other devices, further increasing their versatility and utility. The disclosure also encompasses various configurations and features of the retractable charge cord assembly, such as a nesting connector, a locking charge cord, and a protective cover, among others. These features contribute to the robustness and user-friendliness of the lighting devices, making them suitable for use in a variety of challenging environments.

The retractable charge cord assembly can include features to prevent accidental removal of the charge cord from the assembly. This can be particularly important as the charge cord can be hardwired to internal components, making reinstallation difficult or impossible for the user. The retraction mechanism can incorporate a stop or catch at the base of the charge cord where it enters the housing. This stop can be sized larger than the opening through which the cord exits, preventing the cord from being fully withdrawn from the device. In some implementations, the stop can be a molded feature on the cord itself, or a separate component securely attached to the cord.

Additionally, the retraction mechanism can include a locking feature that engages when the cord is fully extended. This lock can require a deliberate action by the user to release, such as pressing a button or sliding a switch before the cord can be retracted. In some implementations, the retractable charge cord assembly can include a visible indicator or marking on the cord itself, signaling to the user when maximum safe extension has been reached. This indicator can be a color change, texture difference, or printed warning on the cord surface.

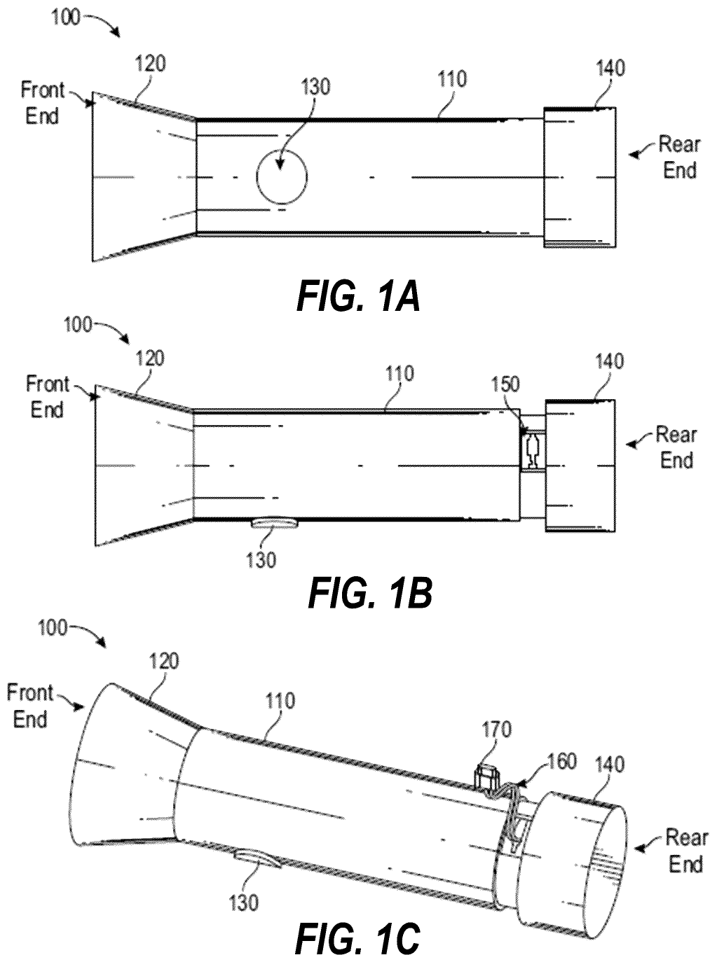

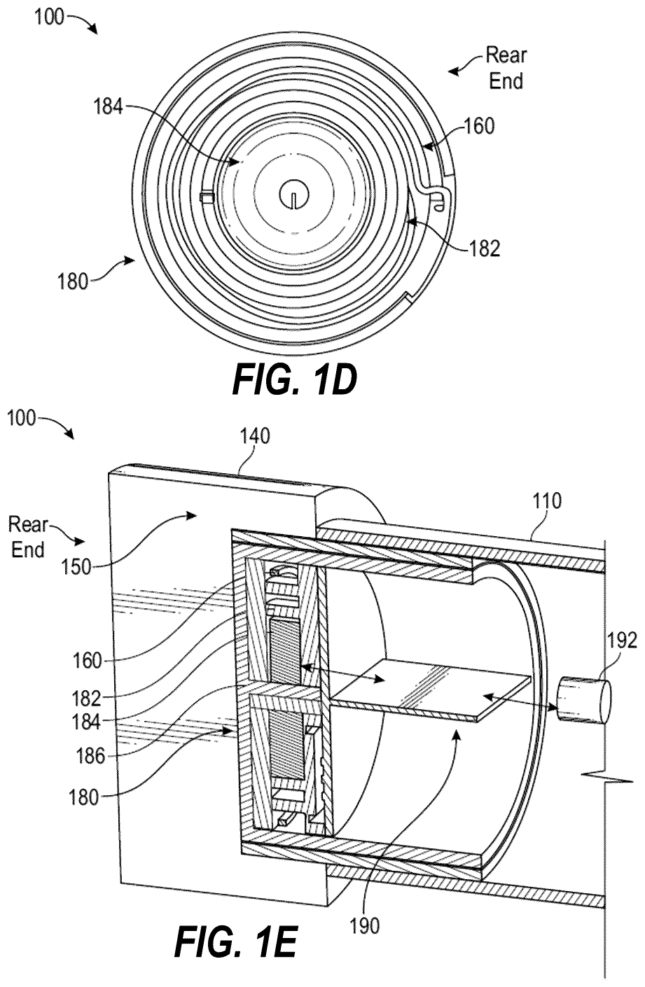

For initial context, FIGS. 1A to 1E collectively illustrate different views of an example lighting device or flashlight 100 according to various aspects and embodiments of the present disclosure. In particular, FIGS. 1A, 1B, and 1C illustrate a top view, a side view, and a perspective view, respectively, of the flashlight 100 according to various aspects and embodiments of the present disclosure. In FIGS. 1B and 1C, a tailcap component on the flashlight 100 shown in FIG. 1A is configured in an open position to illustrate an example nesting location of an example connector and charge cord according to one embodiment. FIG. 1D illustrates a rear end view of the flashlight 100 with a tailcap component removed from view according to various aspects and embodiments of the present disclosure. FIG. 1E illustrates a cutaway perspective view of a rear end region on the flashlight 100 according to various aspects and embodiments of the present disclosure.

The flashlight 100 is illustrated as a representative example of a multi-functional, self-contained, and portable or hand-held lighting device that can function as both a flashlight and a power source for itself and other devices external to the flashlight 100. The concepts described herein can be extended to use with a range of lighting devices of different types, styles, components, and configurations, however. The flashlight 100 includes a power source such as a battery that can be coupled to and charged by a retractable charge cord assembly. The battery can then be used to power the flashlight 100 or another device external to the flashlight 100, thereby eliminating the need for separate charging cables or docking stations and providing significant advantages in convenience, portability, versatility, and utility compared to existing portable or rechargeable flashlights. These features and others described in examples herein allow the flashlight 100 to be suitable for use in a variety of challenging environments.

The flashlight 100 is not drawn to any particular scale or size in the drawings. The shape, size, proportion, and other characteristics of the flashlight 100 and the components thereof can vary as compared to that shown. For example, the flashlight 100 can accommodate different retractable charge cord assembly components, configurations, and locations, and other variations are within the scope of the examples described herein. Additionally, one or more of the parts or components of the flashlight 100, as illustrated in the drawings and described herein, can be omitted in some cases. The flashlight 100 can also include other parts or components that are not illustrated.

Among other components, the flashlight 100 shown in FIGS. 1A-1E includes a housing 110, a light source 120, a power button 130, a tailcap 140, a retractable charge cord assembly 150, a circuit board 190, and a power source or battery 192 in this example. The housing 110 can have an elongated and tapered geometry or cross-section from a wider front end to a narrower rear end that is opposite the front end in some cases. The housing 110 can be constructed from a variety of materials, such as plastic, metal, or a combination thereof, and can be designed to be durable and resistant to environmental factors such as water, dust, and impacts. The light source 120 can be disposed at least partly within the housing 110 at the front end of the flashlight 100 in the example shown. The light source 120 can be at least partly embodied and implemented as any suitable type of light-emitting element, such as a light-emitting diode (LED), an incandescent bulb, or a halogen bulb, among others. The light source 120 can be configured to emit light when powered, providing illumination for a user of the flashlight 100.

The retractable charge cord assembly 150 can be at least partly integrated with the housing 110 such as onto an external portion or into an internal portion of the housing 110 in various examples. The retractable charge cord assembly 150 in the example shown is integrated within the housing 110, although in some cases the retractable charge cord assembly 150 can have at least one of a different configuration, location, or components compared to that shown. The retractable charge cord assembly 150 in this example includes a charge cord 160, a connector 170 coupled to an end of the charge cord 160, and a retraction mechanism 180 configured to extend and retract the charge cord 160. The retraction mechanism 180 can be located at a rear end of the flashlight 100 that is opposite a front end of the flashlight 100 as shown in this example to provide access for a user. However, at least one of the retraction mechanism 180 or the entire retractable charge cord assembly 150 can be positioned at other locations on the flashlight 100 in some examples. The retractable charge cord assembly 150 allows the flashlight 100 to be charged from an external power source, and in some cases, can also allow the flashlight 100 to serve as a power source for charging other devices external to the flashlight 100.

The tailcap 140 can be movable relative to the housing 110. For example, the tailcap 140 can be designed to at least one of slide, rotate, or pivot relative to the housing 110. This movement can reveal the charge cord 160 and the connector 170 of the retractable charge cord assembly 150. The connector 170 in many cases can be at least partly embodied and implemented as a standard universal serial bus (USB) connector, a micro-USB connector, a USB-C connector, or any other type of connector suitable for transmitting power. The connector 170 can be nested within at least one of the tailcap 140 or a portion of the housing 110 when the charge cord 160 is fully retracted in the example shown. This nesting feature can help protect the connector 170 from damage and can also provide a neat and tidy appearance for the flashlight 100. The nesting feature can also prevent the connector 170 from interfering with the operation of the flashlight 100 or becoming entangled with other objects.

Referring to FIGS. 1D and 1E, the retraction mechanism 180 can be at least partly embodied as or otherwise include a wheel or spool 182 around which the charge cord 160 can be wound. The wheel or spool 182 can have a circular geometry or shape and it can be designed to rotate or spin, facilitating the extension and retraction of the charge cord 160. The wheel or spool 182 can be at least partly housed within a compartment or casing 186 within the housing 110 of the flashlight 100 as shown in this example, providing protection and containment for the charge cord 160 when it is not in use.

The retraction mechanism 180 can further include a spring mechanism or spring-like component 184 coupled to the wheel or spool 182. The spring mechanism 184 can be configured to apply a force or tension to the wheel or spool 182, causing it to spin or rotate in a direction that retracts the charge cord 160. The spring mechanism 184 can be designed to be activated or engaged when the charge cord 160 is extended, and to automatically retract the charge cord 160 when the extension force is released. This automatic retraction feature can provide convenience for a user and can help to keep the charge cord 160 neatly stored within the flashlight 100 when not in use.

The circuit board 190 in some examples can be at least partly embodied as or include at least one of a printed circuit board (PCB), a microcontroller, an application-specific integrated circuit (ASIC), or another type of circuit board. The power source or battery 192 can be positioned within the housing 110 and coupled to the retractable charge cord assembly 150 at least in part by way of the circuit board 190 in the example shown. For instance, the retractable charge cord assembly 150 can be coupled to the circuit board 190 and the circuit board 190 can be coupled to the power source or battery 192 as shown in FIG. 1E. The retractable charge cord assembly 150 can further include a power transfer pathway that allows power to flow from an external power source (not illustrated), through the charge cord 160, to the power source or battery 192 in the flashlight 100. This power transfer pathway can be facilitated by electrical connections or conductive materials within the charge cord 160 and the flashlight 100. The power transfer pathway can allow the flashlight 100 to be charged from an external power source, such as a wall outlet or a USB port on a computer or other electronic device.

The retractable charge cord assembly 150 can also be designed to allow power to flow in an opposite direction out of the flashlight 100, from the power source or battery 192, through the charge cord 160, to an external device. This feature can allow the flashlight 100 to serve as a power source or power bank for charging other electronic devices, such as mobile phones, tablets, or other portable lighting devices. The direction of power flow can be controlled in some cases at least in part by way of a switch, a controller, or other control mechanism that can be positioned within the flashlight 100.

The retractable charge cord assembly 150, including the retraction mechanism 180 and the aforementioned power transfer pathway, can be at least partly integrated with or positioned at least partly within the housing 110 of the flashlight 100 in a way that maintains compactness and portability of the flashlight 100. The retractable charge cord assembly 150 can be designed to fit within the confines of the housing 110 in some cases without significantly increasing the size or weight of the flashlight 100 relative to a reference size or weight of the flashlight 100 without the retractable charge cord assembly 150. The integration of the retractable charge cord assembly 150 into the flashlight 100 provides a self-contained, all-in-one solution for lighting and charging needs, enhancing the convenience and versatility of the flashlight 100.

The retraction mechanism 180 on the flashlight 100 in some cases can include a multitude of catches or stops that provide discrete lengths of the charge cord 160 as extended relative to the housing 110 of the flashlight 100. These discrete lengths can correspond to predetermined extension points, such as 1 inch, 3 inches, 6 inches, and so forth. The catches or stops can be implemented through various mechanical means, such as notches, detents, or ratchet-like mechanisms integrated into the retraction mechanism 180.

The retraction mechanism 180 can be designed to allow users to easily extend the charge cord 160 to a desired length and have it lock into place at these predetermined points. This feature can provide users with flexibility in positioning the flashlight 100 relative to an external power source or in managing cable length when charging external devices. The discrete lengths can be marked or indicated on the housing 110 in some examples, allowing users to quickly identify and select the appropriate extension length for their needs.

The retraction mechanism 180 can also incorporate a force-sensitive release feature in some cases. When the charge cord 160 is in an extended position and is tugged with a force beyond a predetermined threshold, it can cause the charge cord 160 to disengage from its current catch or stop position and retract to a subsequent stop position and discrete length. This feature can allow users to easily adjust the length of the charge cord 160 without manually manipulating any locking mechanisms. The force required to trigger this retraction can be calibrated in some cases to prevent accidental retraction during normal use while still allowing for easy adjustment when needed.

Referring to FIG. 1E, the power transfer from the charge cord 160 to the circuit board 190 (e.g., a printed circuit board (PCB)) and subsequently to the power source or battery 192 in the flashlight 100 for charging can be accomplished in some cases through a series of electrical connections and components. The charge cord 160 can be embodied at least in part as or include conductive wires that carry electrical current from an external power source. These wires can terminate at contact points within the housing 110 of the flashlight 100, where they can connect to the circuit board 190.

The circuit board 190 can serve as a central hub for power management within the flashlight 100 in some examples. For instance, the circuit board 190 can include power regulation components such as at least one of voltage regulators, current limiters, or charge controllers in some cases. These components can help to ensure that incoming power is appropriately conditioned for charging the power source or battery 192.

When power flows from the charge cord 160 to the circuit board 190 in some cases, it can first pass through protective circuitry designed to prevent damage from voltage spikes or reverse polarity. The circuit board 190 can process and regulate such incoming power in some examples. The circuit board 190 in some cases can include a dedicated charging integrated circuit (IC) that can manage the charging process while monitoring factors such as voltage, current, and temperature to optimize battery charging and protect against overcharging of the power source or battery 192 or an external power source.

From the circuit board 190, the regulated power can be directed to the power source or battery 192 through additional conductive pathways in some examples. These pathways can be at least partly embodied as or include traces formed on the circuit board 190 itself, as well as wires or other conductive elements that connect the circuit board 190 to terminals on the power source or battery 192. In some embodiments, the circuit board 190 can include sensing circuits that can monitor battery charge state and adjust charging parameters accordingly.

The circuit board 190 in some examples can further include one or more additional components, circuitry, circuit boards, or functionality related to power management. For instance, the circuit board 190 can be embodied such that it can control power distribution to other components on or in the flashlight 100, such as the light source 120 or any additional features like display screens or secondary lighting elements in some cases. The circuit board 190 can also be embodied such that it can manage power output when the flashlight 100 is used as a power bank to charge external devices.

By centralizing power management through the circuit board 190, the flashlight 100 design can achieve efficient and controlled charging of the power source or battery 192 or an external power source while also enabling additional features and protections. This arrangement can allow for a compact and integrated power system within the constraints of the flashlight's 100 form factor.

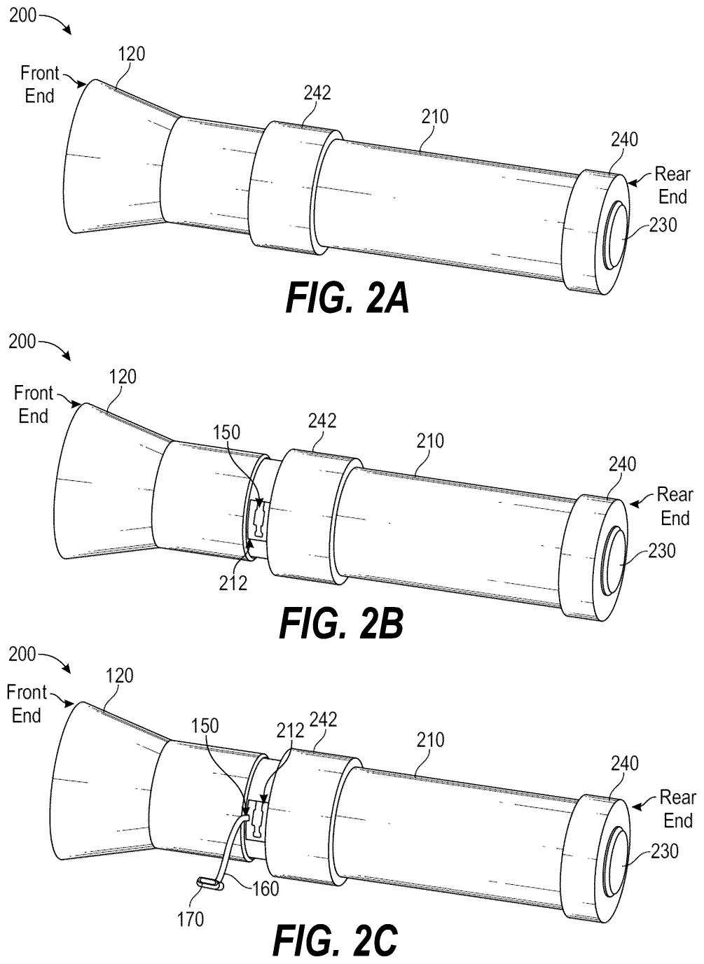

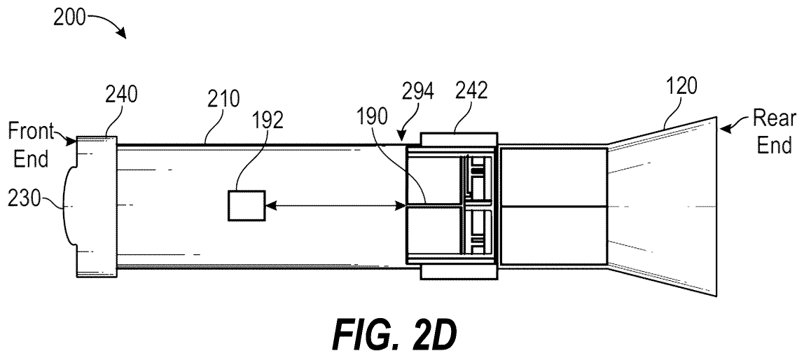

FIGS. 2A to 2D collectively illustrate different views of another example lighting device or flashlight 200 according to various aspects and embodiments of the present disclosure. In particular, FIGS. 2A, 2B, and 2C each illustrate a different perspective view of the flashlight 200 according to various aspects and embodiments of the present disclosure. In FIGS. 2B and 2C, a sleeve or telescoping component on the flashlight 200 shown in FIG. 2A is configured in an open position to illustrate another example nesting location of an example connector and charge cord according to one embodiment. FIG. 2D illustrates a side view of the flashlight 200 with certain components removed from view according to various aspects and embodiments of the present disclosure.

The flashlight 200 is an example alternative embodiment of the flashlight 100 described herein and illustrated in FIGS. 1A-1E. For instance, the flashlight 200 can include and implement one or more of the same or similar components, structure, attributes, features, or functions of the flashlight 100 described herein with reference to FIGS. 1A-1E. The flashlight 200 is illustrated as another representative example of a multi-functional, self-contained, and portable or hand-held lighting device that can function as both a flashlight and a power source for itself and other devices external to the flashlight 200.

The flashlight 200 is not drawn to any particular scale or size in the drawings. The shape, size, proportion, and other characteristics of the flashlight 200 and the components thereof can vary as compared to that shown. For example, the flashlight 200 can accommodate different retractable charge cord assembly components, configurations, and locations, and other variations are within the scope of the examples described herein. Additionally, one or more of the parts or components of the flashlight 200, as illustrated in the drawings and described herein, can be omitted in some cases. The flashlight 200 can also include other parts or components that are not illustrated.

Among other components, the flashlight 200 shown in FIGS. 2A-2D includes a housing 210, the light source 120, a power button 230, a tailcap 240, a sleeve or telescoping body 242, the retractable charge cord assembly 150, the circuit board 190, the power source or battery 192, and an internal power management system 294 in this example.

The housing 210 can have an elongated and tapered geometry or cross-section from a wider or tapered front end to a narrower cylindrical rear end in some cases. The housing 210 can be constructed from a variety of materials, such as plastic, metal, or a combination thereof, and can be designed to be durable and resistant to environmental factors such as water, dust, and impacts. The housing 210 in the example shown includes a compartment or chamber 212 that can at least partly house and protect the charge cord 160 and the connector 170 when not in use. The light source 120 can be disposed at least partly within the housing 210 at the front end of the flashlight 200 in the example shown. The light source 120 can be at least partly embodied and implemented as any suitable type of light-emitting element, such as an LED, an incandescent bulb, or a halogen bulb, among others. The light source 120 can be configured to emit light when powered, providing illumination for a user of the flashlight 200.

Referring to FIGS. 2A-2C, the retractable charge cord assembly 150 on the flashlight 200 can be at least partly integrated with the housing 210 such as onto an external portion or into an internal portion of the housing 210 in various examples. The retractable charge cord assembly 150 in the example shown is integrated into or within a front portion of the housing 210 at or near the light source 120 and the front end of the flashlight 200. For instance, the retractable charge cord assembly 150 can be housed in the compartment or chamber 212 formed in a front portion of the housing 210 at or near the light source 120 and the front end of the flashlight 200 as shown, allowing for easy access and manipulation by a user.

In this configuration, the charge cord 160 can be at least partly nested within a front portion of the housing 210 at or near the light source 120 and the front end of the flashlight 200 when not in use. This nesting feature can help protect the connector 170 from damage and maintain the streamlined profile of the flashlight 200. The flashlight 200 can further include a cover or hatch at least partly integrated into or otherwise moveably coupled to the housing 210 in some cases to protect the charge cord 160 and the connector 170 when not in use. The cover or hatch can be designed to blend seamlessly with the housing 210 in some examples to maintain aesthetic appeal of the flashlight 200 and protect internal components from dust, moisture, and other environmental factors.

With the retractable charge cord assembly 150 located in a front portion of the housing 210 in the example shown, the tailcap 240 can be utilized for other functions. In this configuration, the power button 230 can be situated on the tailcap 240 as shown. This placement can allow for easy operation of the flashlight 200, as a user can comfortably access the power button 230 with their thumb while holding the flashlight 200. The power button 230 can control various functions of the flashlight 200, such as turning the light source 120 on and off, adjusting brightness levels, or activating different lighting modes. By locating the retractable charge cord assembly 150 at a front portion of the housing 210, the weight distribution of the flashlight 200 can be optimized, potentially improving balance and handling. Additionally, this configuration can allow for a more streamlined tailcap design of the tailcap 240, which can enhance the overall aesthetics of the flashlight 200 and provide opportunities for additional features or functionality to be incorporated into the tailcap 240 or surrounding area.

The sleeve or telescoping body 242 on the housing 210 in this example allows access to the compartment or chamber 212. The telescoping body 242 can include one or multiple sections that slide or extend relative to the housing 210 or to one another to reveal the chamber 212 when fully extended. In the example shown, the telescoping body 242 includes one section or sleeve that slides or extends relative to the housing 210 to reveal the chamber 212 when fully extended. The telescoping body 242 can provide an alternative or additional method for accessing the retractable charge cord assembly 150. The telescoping body 242 in some cases can include two or more concentric sections that nest within each other when in a closed position. These sections can be cylindrical in some examples or have other cross-sectional shapes that allow for smooth telescoping action. When a user needs to access the retractable charge cord assembly 150 in the example shown, the user can extend the telescoping body 242 by pulling or twisting it along a length of the housing 210 to reveal the retractable charge cord assembly 150, the charge cord 160, and the connector 170 in the chamber 212.

As the telescoping body 242 extends, it can reveal the chamber 212 within the housing 210 on the flashlight 200 where the retractable charge cord assembly 150 can be nested. The chamber 212 can be designed to protect the charge cord 160 and the connector 170 from environmental factors when the telescoping body 242 is in a closed position covering the chamber 212. The chamber 212 can also include features to secure the connector 170 and prevent tangling of the charge cord 160 when stored in some examples. The telescoping body 242 or other mechanism used to facilitate the telescoping action can include at least one of detents, stops, or locking features that allow the slidable sections on the telescoping body 242 to be secured at various extension lengths. This feature can provide flexibility in how much of the chamber 212 is exposed, allowing users to access the charge cord 160 while maintaining a compact form factor when full extension is not necessary.

In some embodiments, the telescoping body 242 can be spring-loaded at least in part by way of a spring or spring mechanism, allowing for quick and easy extension with a single action. The spring mechanism can be calibrated to provide smooth extension while preventing accidental opening. A release button or latch can be incorporated to disengage the spring mechanism in some cases and allow the telescoping body 242 to be closed. In some examples, the telescoping body 242 can be integrated with other features of the flashlight 200. For instance, extending the telescoping body 242 can automatically activate an internal light to illuminate the chamber 212 in some cases, making it easier to locate and manipulate the charge cord 160 in low-light conditions. Additionally, the extended telescoping body 242 can serve as a stand or support for the flashlight 200 in some cases, providing stability when the flashlight 200 is placed on a surface during charging.

The materials used for at least one of the housing 210 or the telescoping body 242 can be selected to provide durability, weather resistance, and smooth operation. These materials can include, but are not limited to, lightweight metals, high-strength plastics, or composite materials that offer a balance of strength and weight. Seals or gaskets can be incorporated in some cases between telescoping sections on the telescoping body 242 and between the telescoping body 242 and the housing 210 to maintain water and dust resistance of the flashlight 200 when in the closed position.

Referring to FIG. 2D, the internal power management system 294 can direct power between the retractable charge cord assembly 150, the power source or battery 192, and the light source 120. The internal power management system 294 can be at least partly embodied and implemented as a PCB disposed within the housing 210 of the flashlight 200 in some examples. For instance, the internal power management system 294 (e.g., a PCB) can be electrically coupled to the power source or battery 192 and the retractable charge cord assembly 150, allowing for efficient power transfer between these components. The internal power management system 294 can include various electronic components and circuitry designed to regulate and control power flow within the flashlight 200 in some examples. For instance, the internal power management system 294 can include at least one of voltage regulators, current limiters, or charge controllers that can condition incoming power from the charge cord 160 to ensure safe and efficient charging of the power source or battery 192. The internal power management system 294 can also include one or more power distribution circuits that can direct power from the power source or battery 192 to the light source 120 to enabling the flashlight 200 to emit light.

The internal power management system 294 can also manage power output when the flashlight 200 is used to charge external devices. For instance, the internal power management system 294 can include circuitry that allows power to flow from the power source or the battery 192, through the circuit board 190, and out of the flashlight 200 through the charge cord 160 to an external device. Such circuitry on the internal power management system 294 can allow the flashlight 200 to serve as a power bank, providing a convenient power source for charging other electronic devices such as mobile phones, tablets, or other portable lighting devices in some cases.

At least one of the circuit board 190 or the internal power management system 294 can include protective circuitry designed to prevent damage to the flashlight 200 or connected devices in some examples. For instance, one or both of the circuit board 190 or the internal power management system 294 can include overvoltage protection circuits that prevent excessive voltage from damaging the power source or battery 192, the light source 120, or another component on the flashlight 200. Similarly, in some examples one or both of the circuit board 190 or the internal power management system 294 can include short-circuit protection circuits that prevent damage in the event of a short circuit in the charge cord 160 or an external device connected to the charge cord 160. In some cases, at least one of the circuit board 190 or the internal power management system 294 can include a switch (not shown) or other control mechanism that allows a user to select whether to charge the power source or battery 192 in the flashlight 200 or a power source or battery in an external device. The switch can be physically located on the flashlight 200 such as on the housing 210 in some cases, or it can be an electronic switch controlled by at least one of the circuit board 190 or the internal power management system 294 in other examples. In some cases, at least one of the circuit board 190 or the internal power management system 294 can include circuitry that can detect the switch position and direct power flow accordingly.

The power transfer from the charging cord 160 to the circuit board 190 and subsequently to one or both of the light source 120 or the power source or battery 192 of the flashlight 200 for power or charging can be accomplished through a series of electrical connections and components in some examples. For instance, the charge cord 160 can include conductive wires that carry electrical current from an external power source. These wires can terminate at contact points within the housing 210, where they can connect to the circuit board 190.

The circuit board 190, which can be a microcontroller, ASIC, or another type of circuit board, can serve as the central hub for power management within the flashlight 200. The circuit board 190 can include power regulation components such as voltage regulators, current limiters, or charge controllers. These components can help to ensure that the incoming power is appropriately conditioned for charging the power source or battery 192 and powering the light source 120 in some cases.

When power flows from the charging cord 160 to the circuit board 190, it can first pass through protective circuitry designed to prevent damage from voltage spikes or reverse polarity. The circuit board 190 can then process and regulate this incoming power. The circuit board 190 can include a dedicated charging integrated circuit (IC) that manages the charging process, monitoring factors such as voltage, current, and temperature to optimize battery charging and protect against overcharging.

From the circuit board 190, the regulated power can be directed to at least one of the light source 120 or the power source or battery 192 through additional conductive pathways. These pathways can include traces on the circuit board 190 itself, as well as wires or other conductive elements that connect the circuit board 190 to terminals such as battery terminals on the power source or battery 192. In some embodiments, the circuit board 190 can include and implement sensing circuits that can monitor a battery's charge state and adjust charging parameters accordingly.

The circuit board 190 can also include additional functionality related to power management. For instance, it can control power distribution to other components of the flashlight 200, such as the light source 120 or any additional features like display screens or secondary lighting elements. The circuit board 190 can also manage power output when the flashlight 200 is used as a power bank to charge external devices.

By centralizing power management through the circuit board 190, the flashlight 200 can achieve efficient and controlled charging of the power source or battery 192 while also enabling additional features and protections. This arrangement can allow for a compact and integrated power system within the constraints of the flashlight's 200 form factor.

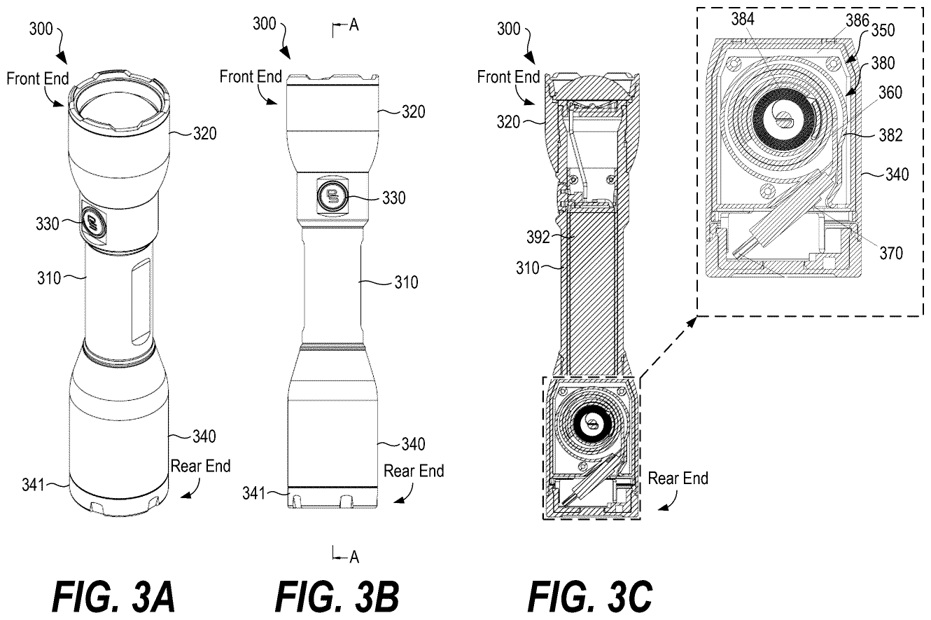

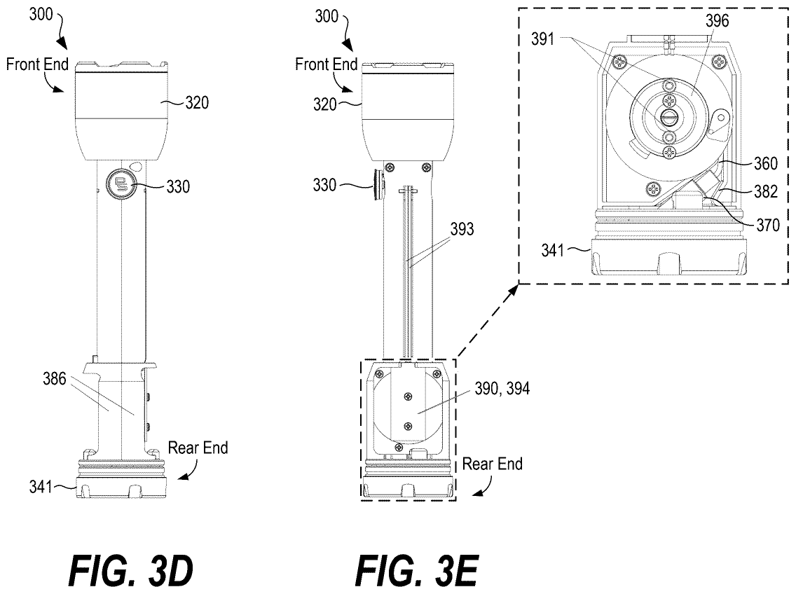

FIGS. 3A to 3E collectively illustrate different views of another example lighting device or flashlight 300 according to various aspects and embodiments of the present disclosure. In particular, FIGS. 3A and 3B illustrate a perspective view and a top view, respectively, of the flashlight 300 according to various aspects and embodiments of the present disclosure. FIG. 3C illustrates a cross-sectional top view of the flashlight 300 designated A-A in FIG. 3B according to various aspects and embodiments of the present disclosure. FIGS. 3D and 3E illustrate a top view and a side view, respectively, of the flashlight 300 with certain components removed according to various aspects and embodiments of the present disclosure.

The flashlight 300 is an example alternative embodiment of the flashlight 100 described herein and illustrated in FIGS. 3A-3E. For instance, the flashlight 300 can include and implement one or more of the same or similar components, structure, attributes, features, or functions of the flashlight 100 described herein with reference to FIGS. 3A-3E. The flashlight 300 is illustrated as another representative example of a multi-functional, self-contained, and portable or hand-held lighting device that can function as both a flashlight and a power source for itself and other devices external to the flashlight 300.

The flashlight 300 is not drawn to any particular scale or size in the drawings. The shape, size, proportion, and other characteristics of the flashlight 300 and the components thereof can vary as compared to that shown. For example, the flashlight 300 can accommodate different retractable charge cord assembly components, configurations, and locations, and other variations are within the scope of the examples described herein. Additionally, one or more of the parts or components of the flashlight 300, as illustrated in the drawings and described herein, can be omitted in some cases. The flashlight 300 can also include other parts or components that are not illustrated.

Among other components, the flashlight 300 shown in FIGS. 3A-3E includes a housing 310, a light source 320, a power button 330, a tailcap 340, a retractable charge cord assembly 350, a stationary circuit board 390, a power source or battery 392, an internal power management system 394, and a rotating circuit board 396 in this example. The housing 310 can have an elongated and tapered geometry or cross-section from a wider geometry or cross-section at each of the front and rear ends to a narrower geometry or cross-section at a center or the housing 310 in some cases. The housing 310 can be constructed from a variety of materials, such as plastic, metal, or a combination thereof, and can be designed to be durable and resistant to environmental factors such as water, dust, and impacts. The light source 320 can be disposed at least partly within the housing 310 at the front end of the flashlight 300 as shown in this example and it can be at least partly embodied and implemented as an LED, an incandescent bulb, or a halogen bulb, among others in some cases.

The retractable charge cord assembly 350 can be at least partly integrated with at least one of the housing 310 or the tailcap 340 such as onto an external portion or into an internal portion of one or both of such components in various examples. The retractable charge cord assembly 350 in the example shown is at least partly integrated into or within one or both of the housing 310 or the tailcap 340. The retractable charge cord assembly 350 in this example includes a charge cord 360, a connector 370 coupled to an end of the charge cord 360, and a retraction mechanism 380 configured to extend and retract the charge cord 360. The retraction mechanism 380 can be located at the rear end of the flashlight 300 as shown in this example to provide access for a user.

At least a portion of the tailcap 340 can be movable relative to the housing 310. For example, a screw cap 341 at a rear end portion on the tailcap 340 can be designed to at least one of unscrew, twist, rotate, or pivot relative to the housing 310. For instance, unscrewing the screw cap 341 on the tailcap 340 from the housing 310 can reveal the charge cord 360 and the connector 370 of the retractable charge cord assembly 350. The connector 370 in many cases can be at least partly embodied and implemented as a USB connector, a micro-USB connector, a USB-C connector, or any other type of connector suitable for transmitting power. The connector 370 can be nested within at least one of the tailcap 340 or a portion of the housing 310 when the charge cord 360 is fully retracted in the example shown.

Referring to FIGS. 3C and 3E, the retraction mechanism 380 can include a wheel or spool structure 382 around which the charge cord 360 can be wound. The wheel or spool 382 can have a circular geometry or shape and it can be designed to rotate or spin, facilitating the extension and retraction of the charge cord 360. The wheel or spool 382 can be at least partly housed within a compartment or casing 386 within the housing 310 of the flashlight 300 as shown in this example, providing protection and containment for the charge cord 360 when it is not in use.

The retraction mechanism 380 can further include a spring mechanism or spring-like component 384 coupled to the wheel or spool 382. The spring mechanism 384 can be configured to apply a force or tension to the wheel or spool 382, causing it to spin or rotate in a direction that retracts the charge cord 360. The spring mechanism 384 can be designed to be activated or engaged when the charge cord 360 is extended, and to automatically retract the charge cord 360 when the extension force is released to store the charge cord 360 neatly within the flashlight 300 when not in use.

The retraction mechanism 380 in some cases can further include a multitude of catches or stops (e.g., notches, detents, ratchet-like mechanisms) that provide discrete lengths of the charge cord 360 as extended relative to the housing 310, such as 1 inch, 3 inches, 6 inches, and so forth. The retraction mechanism 380 can be designed to allow users to easily extend the charge cord 360 to a desired length and have it lock into place at these predetermined points, which can be marked or indicated on the housing 310 in some examples. The retraction mechanism 380 can also incorporate a force-sensitive release feature in some cases. When the charge cord 360 is in an extended position and is tugged with a force beyond a predetermined threshold, it can cause the charge cord 360 to disengage from its current catch or stop position and retract to a subsequent stop position and discrete length.

One or both of the stationary circuit board 390 or the rotating circuit board 396 in the example shown can be at least partly embodied as or include at least one of a PCB, a microcontroller, an ASIC, or another type of circuit board. The power source or battery 392 can be positioned within the housing 310 and coupled to the retractable charge cord assembly 350 at least in part by way of the stationary circuit board 390 in the example shown. For instance, the retractable charge cord assembly 350 can be coupled to the stationary circuit board 390 and the stationary circuit board 390 can include or be coupled to the power source or battery 392 as shown in FIG. 3E.

The retractable charge cord assembly 350 can further include a power transfer pathway that allows power to flow from an external power source (not illustrated), through the charge cord 360, to the power source or battery 392 in the flashlight 300. This power transfer pathway can be facilitated by electrical connections or conductive materials within the charge cord 360 and the flashlight 300. The power transfer pathway can allow the flashlight 300 to be charged from an external power source, such as a wall outlet or a USB port on a computer or other electronic device.

The retractable charge cord assembly 350 can also be designed to allow power to flow in an opposite direction out of the flashlight 300, from the power source or battery 392, through the charge cord 360, to an external device. This feature can allow the flashlight 300 to serve as a power source or power bank for charging other electronic devices, such as mobile phones, tablets, or other portable lighting devices. The direction of power flow can be controlled in some cases at least in part by way of a switch, a controller, or other control mechanism that can be positioned within the flashlight 300.

The retractable charge cord assembly 350, including the retraction mechanism 380 and the aforementioned power transfer pathway, can be at least partly integrated with or positioned at least partly within one or both of the housing 310 or the tailcap 340 on the flashlight 300 in a way that maintains compactness and portability of the flashlight 300. The retractable charge cord assembly 350 can be designed to fit within the confines of at least one of the housing 310 or the tailcap 340 in some cases without significantly increasing the size or weight of the flashlight 300 relative to a reference size or weight of the flashlight 300 without the retractable charge cord assembly 350. The integration of the retractable charge cord assembly 350 into the flashlight 300 as shown in this example provides a self-contained, all-in-one solution for lighting and charging needs, enhancing the convenience and versatility of the flashlight 300.

The power transfer from the charge cord 360 to the rotating circuit board 396, then to the stationary circuit board 390 (e.g., a PCB), and subsequently to the power source or battery 392 in the flashlight 300 for charging can be accomplished in some cases through a series of electrical connections and components. The charge cord 360 can be embodied at least in part as or include conductive wires that can carry electrical current from an external power source. These wires in the charge cord 360 can terminate at contact points on the rotating circuit board 396 within the tailcap 340 on the flashlight 300. For instance, in some cases the wires in the charge cord 360 can terminate at spring connectors 391 on the rotating circuit board 396 that maintain electrical connection or coupling of the stationary circuit board 390 and the rotating circuit board 396.

The stationary circuit board 390 can serve as a central hub for power management within the flashlight 300 at least in part by way of the internal power management system 394 in some examples. For instance, the stationary circuit board 390 can include power regulation components such as at least one of voltage regulators, current limiters, or charge controllers in some cases. The internal power management system 394 can use such components to ensure incoming power is appropriately conditioned for charging the power source or battery 392.

When power flows from the charge cord 360 to the stationary circuit board 390 in some cases, it can first pass through protective circuitry designed to prevent damage from voltage spikes or reverse polarity. The stationary circuit board 390 can process and regulate such incoming power in some examples. The stationary circuit board 390 in some cases can include a dedicated charging integrated circuit (IC) that can manage the charging process while monitoring factors such as voltage, current, and temperature to optimize battery charging and protect against overcharging of the power source or battery 392 or an external power source.

From the stationary circuit board 390, the regulated power can be directed to the power source or battery 392 through additional conductive pathways such as wires 393 in some examples. The wires 393 can be at least partly embodied as or include traces formed on the stationary circuit board 390 itself, as well as wires or other conductive elements that connect the stationary circuit board 390 to terminals on the power source or battery 392. In some embodiments, the stationary circuit board 390 can include sensing circuits that can be used by the internal power management system 394 to monitor battery charge state and adjust charging parameters accordingly.

The stationary circuit board 390 in some examples can further include one or more additional components, circuitry, circuit boards, or functionality related to power management. For instance, the stationary circuit board 390 can be embodied such that the internal power management system 394 can control power distribution to other components on or in the flashlight 300, such as the light source 320 or any additional features like display screens or secondary lighting elements in some cases. The stationary circuit board 390 can also be embodied such that the internal power management system 394 can manage power output when the flashlight 300 is used as a power bank to charge external devices.

By centralizing power management through the stationary circuit board 390 and the internal power management system 394, the flashlight 300 design can achieve efficient and controlled charging of the power source or battery 392 or an external power source while also enabling additional features and protections. This arrangement can allow for a compact and integrated power system within the constraints of the flashlight's 300 form factor.

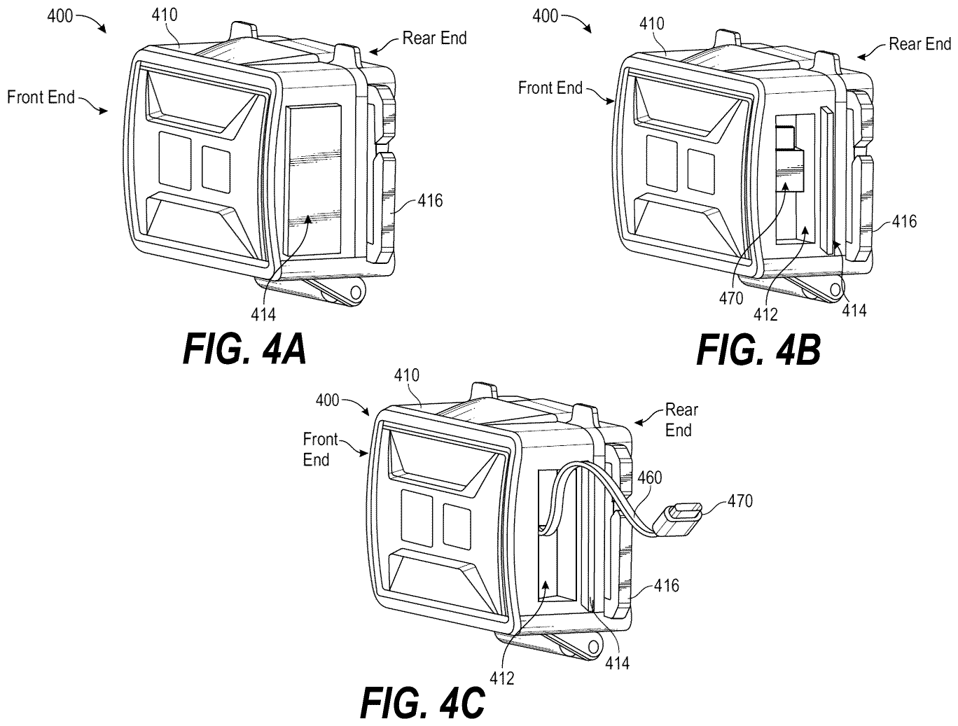

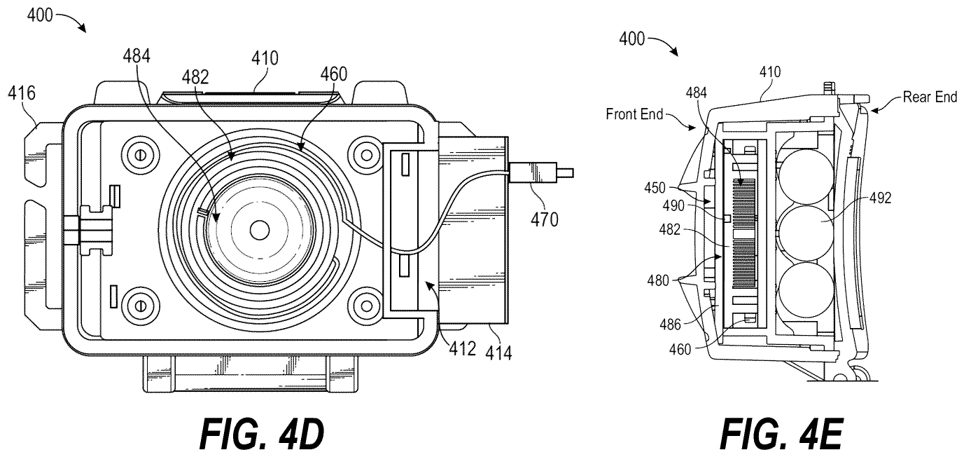

FIGS. 4A to 4E collectively illustrate different views of an example lighting device or headlamp battery pack 400 according to various aspects and embodiments of the present disclosure. In particular, FIGS. 4A, 4B, and 4C each illustrate a different perspective view of the headlamp battery pack 400 according to various aspects and embodiments of the present disclosure. In FIGS. 4B and 4C, a cover component on the headlamp battery pack 400 shown in FIG. 4A is configured in an open position to illustrate an example nesting location of an example connector and charge cord according to one embodiment. FIGS. 4D and 4E illustrate a cross-sectional front and side view, respectively, of the headlamp battery pack 400 according to various aspects and embodiments of the present disclosure.

The headlamp battery pack 400 is illustrated as a representative example of a multi-functional, self-contained, and portable or wearable lighting device battery pack that can function as a power source for its own corresponding lighting device such as headlamp and other devices external to the headlamp battery pack 400. The concepts described herein can be extended to use with a range of lighting devices of different types, styles, components, and configurations, however. The headlamp battery pack 400 includes a power source such as a battery that can be coupled to and charged by a retractable charge cord assembly. The battery can then be used to power a lighting device that corresponds to and cooperates with the headlamp battery pack 400 such as a headlamp or another device external to the headlamp battery pack 400, thereby eliminating the need for separate charging cables or docking stations and providing significant advantages in convenience, portability, versatility, and utility compared to existing portable or rechargeable flashlights. These features and others described in examples herein allow the headlamp battery pack 400 to be suitable for use in a variety of challenging environments.

The headlamp battery pack 400 is not drawn to any particular scale or size in the drawings. The shape, size, proportion, and other characteristics of the headlamp battery pack 400 and the components thereof can vary as compared to that shown. For example, the headlamp battery pack 400 can accommodate different retractable charge cord assembly components, configurations, and locations, and other variations are within the scope of the examples described herein. Additionally, one or more of the parts or components of the headlamp battery pack 400, as illustrated in the drawings and described herein, can be omitted in some cases. The headlamp battery pack 400 can also include other parts or components that are not illustrated.

Among other components, the headlamp battery pack 400 shown in FIGS. 4A-4E includes a housing 410, a retractable charge cord assembly 450, a circuit board 490, and a power source or battery 492 in this example. The housing 410 can be constructed from a variety of materials, such as plastic, metal, or a combination thereof in some cases. The housing 410 can be designed to be durable and resistant to environmental factors such as water, dust, and impacts.

The retractable charge cord assembly 450 includes a charge cord 460, a connector 470 coupled to an end of the charge cord 460, and a retraction mechanism 480 configured to extend and retract the charge cord 460 and the connector 470 in this example. The retraction mechanism 480 can be at least partly embodied as or otherwise include a wheel or spool structure 482 around which the charge cord 460 can be wound, and a spring or spring-like mechanism or system 484 that can facilitate automatic retraction of the charge cord 460 and the connector 470 when not in use as shown in this example.

Referring to FIGS. 4D and 4E, the wheel or spool 482 can have a circular geometry or shape and it can be embodied and implemented to rotate or spin, facilitating the extension and retraction of the charge cord 460 in some cases. The wheel or spool 482 can be housed within a compartment or casing 486 within the housing 410 of the headlamp battery pack 400 as shown in this example to provide protection and containment for the charge cord 460 when it is not in use.

The spring mechanism 484 is coupled to the wheel or spool 482 in the example shown. The spring mechanism 484 can be embodied, configured, and implemented in this example to apply a force or tension to the wheel or spool 482, causing the wheel or spool 482 to spin or rotate in a direction that retracts the charge cord 460. This automatic retraction feature can provide convenience for a user and can help to keep the charge cord 460 and the connector 470 neatly stored within the housing 410 when not in use. The headlamp battery pack 400 and the retractable charge cord assembly 450 can be designed to allow the charge cord 460 to extend and retract to great lengths in various examples. In some examples, the spring mechanism 484 on the retraction mechanism 480 can be designed to support extension and retraction without creating limitations at any cord length. This feature can provide additional flexibility and convenience for a user, allowing for a wide range of charging or power transfer scenarios.

The connector 470 at the end of the charge cord 460 can be embodied and implemented as a USB connector, a micro-USB connector, a USB-C connector, or any other type of connector suitable for transmitting power in some cases. The connector 470 can be configured to nest on or within a portion of the housing 410 when the charge cord 460 is fully retracted as shown in this example. This nesting feature can help protect the connector 470 from damage and can also provide a neat and tidy appearance for the headlamp battery pack 400. For instance, the connector 470 can be designed to fit snugly within a recess or cavity 412 in the housing 410 as shown to prevent the charge cord 460 and the connector 470 from protruding or dangling when not in use. The nesting feature can also prevent the charge cord 460 and the connector 470 from interfering with the operation of the headlamp battery pack 400 or becoming entangled with other objects.

The connector 470 can be designed to nest within at least one of the housing 410 or the recess or cavity 412 in various ways. For example, the connector 470 can have a press-fit or magnetic fit that allows it to nest within the housing 410. A press-fit design can involve the connector 470 having a certain shape that matches a corresponding shape of a portion of the housing 410 in some cases, allowing the connector 470 to be pressed into place. A magnetic fit can involve the use of magnets or magnetic materials in at least one of the connector 470 or the housing 410 in some examples, allowing the connector 470 to be held in place by magnetic attraction. These nesting features can provide a secure and reliable way to store the connector 470 when the charge cord 460 is retracted, while also allowing for easy access and removal when the charge cord 460 is to be extended for use.

The headlamp battery pack 400 in the example shown further includes a cover 414 that can be movably coupled to the housing 410. The cover 414 can be designed to at least partly overlap, cover, and conceal the connector 470 when the cover 414 is in a closed position. The cover 414 can be embodied as a separate component that can be attached to the housing 410 in some cases, or the cover 414 can be an integral part of the housing 410 that can be manipulated to reveal or conceal the connector 470 in other cases. The cover 414 can be designed to move in various ways, such as at least one of sliding, pivoting, or rotating, to reveal the connector 470 in some examples. The cover 414 in some cases can include one or more of a latch, a catch, or another type of locking mechanism that secures the cover 414 in the closed position, helping to protect the connector 470 and charge cord 460 from environmental factors.

The headlamp battery pack 400 in the example shown further includes a strap attachment mechanism 416 that can be used to couple the headlamp battery pack 400 to a headlamp strap (not illustrated). The strap attachment mechanism 416 can include at least one of clips, hooks, or other types of fasteners that can securely attach the headlamp battery pack 400 to a headlamp strap. The strap attachment mechanism 416 can be embodied to allow for easy attachment and detachment of the headlamp battery pack 400, providing convenience and flexibility for a user.

The headlamp battery pack 400 can be embodied to receive power through the retractable charge cord assembly 450 to charge the power source or battery 492 in some cases. This charging feature can allow the headlamp battery pack 400 to serve as a power source for a headlamp in some examples, providing a convenient and integrated solution for powering the headlamp. The retractable charge cord assembly 450 can also allow the headlamp battery pack 400 to be charged from an external power source, such as a wall outlet or a USB port on a computer or other electronic device.

The circuit board 490 in some examples can be at least partly embodied as or include at least one of a PCB, a microcontroller, an ASIC, or another type of circuit board. The power source or battery 492 can be at least partly integrated or otherwise positioned within the housing 410 in the example shown. The power source or battery 492 can be at least partly embodied and implemented as a rechargeable battery or a set of batteries that provide power to a headlamp in some cases. The power source or battery 492 can be electrically coupled to the retractable charge cord assembly 450, which can also be at least partly integrated or otherwise positioned within the housing 410 in the example shown.

The power source or battery 492 can be coupled to the retractable charge cord assembly 450 at least in part by way of the circuit board 490 in the example shown. For instance, the retractable charge cord assembly 450 can be coupled to the circuit board 490 and the circuit board 490 can be coupled to the power source or battery 492. The retractable charge cord assembly 450 can further include a power transfer pathway that allows power to flow from an external power source (not illustrated), through the charge cord 460, to the power source or battery 492 in the headlamp battery pack 400. This power transfer pathway can be facilitated by electrical connections or conductive materials within the charge cord 460 and the headlamp battery pack 400. The power transfer pathway can allow the headlamp battery pack 400 to be charged from an external power source, such as a wall outlet or a USB port on a computer or other electronic device.

The retractable charge cord assembly 450 can also be designed to allow power to flow in an opposite direction out of the headlamp battery pack 400, from the power source or battery 492, through the charge cord 460, to an external device. This feature can allow the headlamp battery pack 400 to serve as a power source or power bank for charging other electronic devices, such as mobile phones, tablets, or other portable lighting devices. The direction of power flow can be controlled in some cases at least in part by way of a switch, a controller, or other control mechanism that can be positioned within the headlamp battery pack 400.

The retractable charge cord assembly 450, including the retraction mechanism 480 and the aforementioned power transfer pathway, can be at least partly integrated with or positioned at least partly within the housing 410 of the headlamp battery pack 400 in a way that maintains compactness and portability of the headlamp battery pack 400. The retractable charge cord assembly 450 can be designed to fit within the confines of the housing 410 in some cases without significantly increasing the size or weight of the headlamp battery pack 400 relative to a reference size or weight of the headlamp battery pack 400 without the retractable charge cord assembly 450. The integration of the retractable charge cord assembly 450 into the headlamp battery pack 400 provides a self-contained, all-in-one solution for headlamp lighting and charging needs, enhancing the convenience and versatility of the headlamp battery pack 400.

The retraction mechanism 480 on the headlamp battery pack 400 in some cases can include a multitude of catches or stops that provide discrete lengths of the charge cord 460 as extended relative to the housing 410 of the headlamp battery pack 400. These discrete lengths can correspond to predetermined extension points, such as 1 inch, 3 inches, 6 inches, and so forth. The catches or stops can be implemented through various mechanical means, such as notches, detents, or ratchet-like mechanisms integrated into the retraction mechanism 480.

The retraction mechanism 480 can be designed to allow users to easily extend the charge cord 460 to a desired length and have it lock into place at predetermined extension points. This feature can provide users with flexibility in positioning the headlamp battery pack 400 relative to an external power source or in managing cable length when charging external devices. The discrete lengths can be marked or indicated on the housing 410 in some examples, allowing users to quickly identify and select the appropriate extension length for their needs.

The retraction mechanism 480 can also incorporate a force-sensitive release feature in some cases. When the charge cord 460 is in an extended position and is tugged with a force beyond a predetermined threshold, it can cause the charge cord 460 to disengage from its current catch or stop position and retract to a subsequent stop position and discrete length. This feature can allow users to easily adjust the length of the charge cord 460 without manually manipulating any locking mechanisms. The force required to trigger this retraction can be calibrated in some cases to prevent accidental retraction during normal use while still allowing for easy adjustment when needed.

Referring to FIGS. 4D and 4E, the power transfer from the charge cord 460 to the circuit board 490 (e.g., a PCB) and subsequently to the power source or battery 492 in the headlamp battery pack 400 for charging can be accomplished in some cases through a series of electrical connections and components. The charge cord 460 can be embodied at least in part as or include conductive wires that carry electrical current from an external power source. These wires can terminate at contact points within the housing 410 of the headlamp battery pack 400, where they can connect to the circuit board 490.

The circuit board 490 can serve as a central hub for power management within the headlamp battery pack 400 in some examples. For instance, the circuit board 490 can include power regulation components such as at least one of voltage regulators, current limiters, or charge controllers in some cases. These components can help to ensure that incoming power is appropriately conditioned for charging the power source or battery 492.

When power flows from the charge cord 460 to the circuit board 490 in some cases, it can first pass through protective circuitry designed to prevent damage from voltage spikes or reverse polarity. The circuit board 490 can process and regulate such incoming power in some examples. The circuit board 490 in some cases can include a dedicated charging integrated circuit (IC) that can manage the charging process while monitoring factors such as voltage, current, and temperature to optimize battery charging and protect against overcharging of the power source or battery 492 or an external power source.

From the circuit board 490, the regulated power can be directed to the power source or battery 492 through additional conductive pathways in some examples. These pathways can be at least partly embodied as or include traces formed on the circuit board 490 itself, as well as wires or other conductive elements that connect the circuit board 490 to terminals on the power source or battery 492. In some embodiments, the circuit board 490 can include sensing circuits that can monitor battery charge state and adjust charging parameters accordingly.

The circuit board 490 in some examples can further include one or more additional components, circuitry, circuit boards, or functionality related to power management. For instance, the circuit board 490 can be embodied such that it can control power distribution to other components on, in, or coupled to the headlamp battery pack 400, such as a light source on a headlamp that can be coupled to the headlamp battery pack 400 or any additional features like display screens or secondary lighting elements in some cases. The circuit board 490 can also be embodied such that it can manage power output when the headlamp battery pack 400 is used as a power bank to charge external devices.

By centralizing power management through the circuit board 490, the headlamp battery pack 400 design can achieve efficient and controlled charging of the power source or battery 492 or an external power source while also enabling additional features and protections. This arrangement can allow for a compact and integrated power system within the constraints of the headlamp battery pack's 400 form factor.

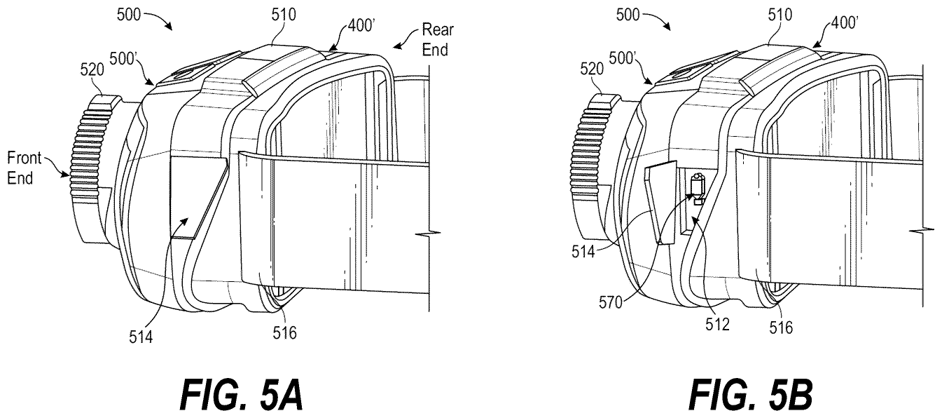

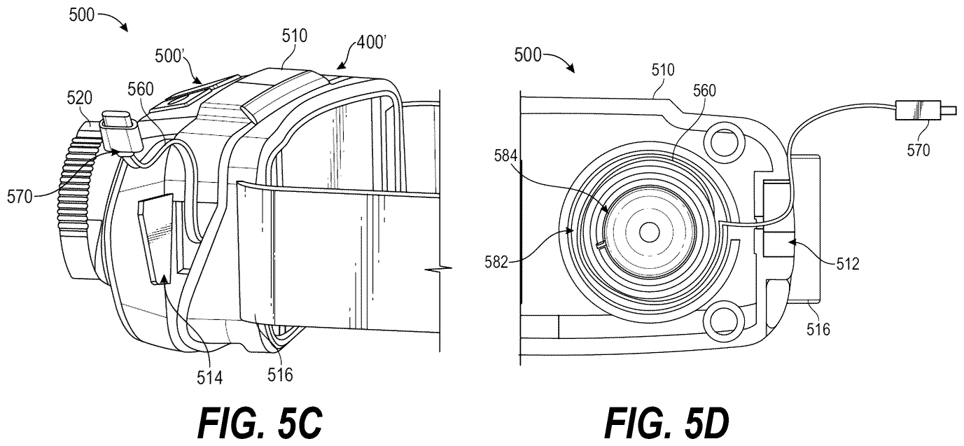

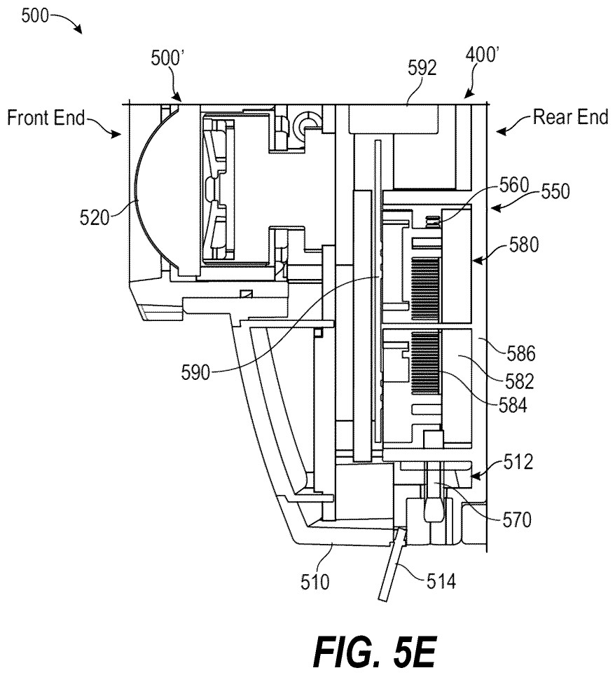

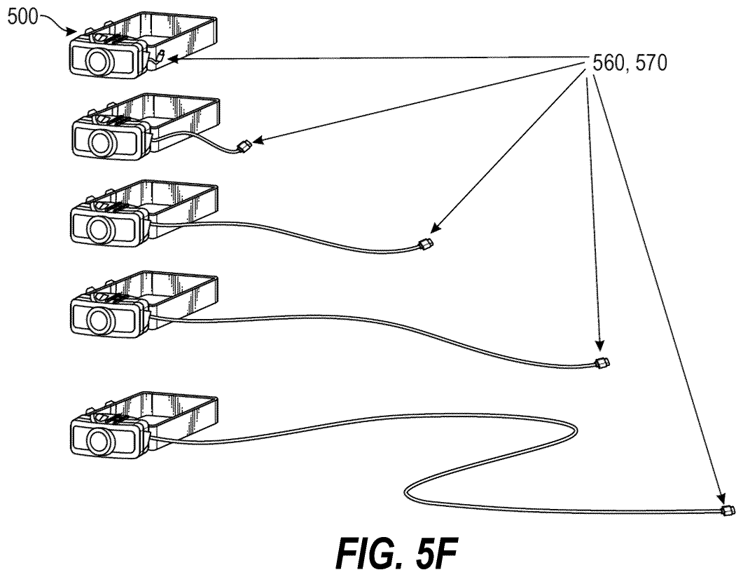

FIGS. 5A to 5F collectively illustrate different views of another example lighting device or headlamp 500 according to various aspects and embodiments of the present disclosure. In particular, FIGS. 5A, 5B, and 5C each illustrate a different perspective view of the headlamp 500 according to various aspects and embodiments of the present disclosure. In FIGS. 5B and 5C, a cover component on the headlamp 500 shown in FIG. 5A is configured in an open position to illustrate another example nesting location of an example connector and charge cord according to one embodiment. FIGS. 5D and 5E illustrate a cross-sectional front and side view, respectively, of the headlamp 500 according to various aspects and embodiments of the present disclosure. FIG. 5F illustrates example retractable charge cord assembly extension states of the headlamp 500 according to various aspects and embodiments of the present disclosure.

The headlamp 500 is an example alternative embodiment of the headlamp battery pack 400 described herein and illustrated in FIGS. 4A-4E. For instance, the headlamp 500 can include and implement one or more of the same or similar components, structure, attributes, features, or functions of the headlamp battery pack 400 described herein with reference to FIGS. 4A-4E. The headlamp 500 is illustrated as another representative example of a multi-functional, self-contained, and portable or wearable lighting device battery pack that can function as a power source for its own corresponding lighting device such as headlamp and other devices external to the headlamp 500. In some examples, the headlamp 500 can be embodied and implemented as a headlamp having a head or light source unit coupled (e.g., electrically, communicatively, mechanically) to the headlamp battery pack 400.

The headlamp 500 is not drawn to any particular scale or size in the drawings. The shape, size, proportion, and other characteristics of the headlamp 500 and the components thereof can vary as compared to that shown. For example, the headlamp 500 can accommodate different retractable charge cord assembly components, configurations, and locations, and other variations are within the scope of the examples described herein. Additionally, one or more of the parts or components of the headlamp 500, as illustrated in the drawings and described herein, can be omitted in some cases. The headlamp 500 can also include other parts or components that are not illustrated.

Among other components, the headlamp 500 shown in FIGS. 5A-5F includes a headlamp unit 500′ at a front end of the headlamp 500 and a headlamp battery pack 400′ at a rear end of the headlamp 500. The headlamp battery pack 400′ in the example shown is an example alternative embodiment of the headlamp battery pack 400 described herein and illustrated in FIGS. 4A-4E. For instance, the headlamp battery pack 400′ can include and implement one or more of the same or similar components, structure, attributes, features, or functions of the headlamp battery pack 400 described herein with reference to FIGS. 4A-4E. The headlamp unit 500′ and the headlamp battery pack 400′ can be at least partly embodied as integral or permanently coupled components on the headlamp 500 in some cases or as removably or detachably coupled components on the headlamp 500 in other cases.

The headlamp 500 in the example shown further includes a housing 510, a light source 520, a retractable charge cord assembly 550, a circuit board 590, and a power source or battery 592 in this example. The light source 520 is included on the headlamp unit 500′ along with other components in this example and the headlamp battery pack 400′ includes the retractable charge cord assembly 550, the circuit board 590, the power source or battery 592, and additional components described below. The housing 510 can at least partly envelope and house at least one of the headlamp unit 500′ or the headlamp battery pack 400′ in various examples. The housing 510 can be constructed from a variety of materials, such as plastic, metal, or a combination thereof in some cases. The housing 510 can be designed to be durable and resistant to environmental factors such as water, dust, and impacts.

The light source 520 can be disposed at least partly within the housing 510 on the headlamp unit 500′ at the front end of the headlamp 500 in the example shown. The light source 520 can be at least partly embodied and implemented as any suitable type of light-emitting element, such as an LED, an incandescent bulb, or a halogen bulb, among others. The light source 520 can be configured to emit light when powered, providing illumination for a user of the headlamp 500.

The retractable charge cord assembly 550 in the example shown is an example alternative embodiment of the retractable charge cord assembly 450 described herein and illustrated in FIGS. 4A-4E. For instance, the retractable charge cord assembly 550 can include and implement one or more of the same or similar components, structure, attributes, features, or functions of the retractable charge cord assembly 450 described herein with reference to FIGS. 4A-4E. The retractable charge cord assembly 550 includes a charge cord 560, a connector 570 coupled to an end of the charge cord 560, and a retraction mechanism 580 configured to extend and retract the charge cord 560 and the connector 570 in this example. The retraction mechanism 580 can be at least partly embodied as or otherwise include a wheel or spool structure 582 around which the charge cord 560 can be wound, and a spring or spring-like mechanism or system 584 that can facilitate automatic retraction of the charge cord 560 and the connector 570 when not in use as shown in this example.

Referring to FIGS. 5D and 5E, the wheel or spool 582 can have a circular geometry or shape and it can be embodied and implemented to rotate or spin, facilitating the extension and retraction of the charge cord 560 in some cases. The wheel or spool 582 can be housed within a compartment or casing 586 within the housing 510 on the headlamp battery pack 400′ as shown in this example to provide protection and containment for the charge cord 560 when it is not in use.

The spring mechanism 584 is coupled to the wheel or spool 582 in the example shown. The spring mechanism 584 can be embodied, configured, and implemented in this example to apply a force or tension to the wheel or spool 582, causing the wheel or spool 582 to spin or rotate in a direction that retracts the charge cord 560. The headlamp battery pack 400′ and the retractable charge cord assembly 550 can be designed to allow the charge cord 560 to extend and retract to various lengths.

The connector 570 at the end of the charge cord 560 can be embodied and implemented as a USB connector, a micro-USB connector, a USB-C connector, or any other type of connector suitable for transmitting power in some cases. The connector 570 can be configured to nest on or within a portion of the housing 510 when the charge cord 560 is fully retracted as shown in this example. For instance, the connector 570 can be designed to fit snugly within a recess or cavity 512 in the housing 510 on the headlamp battery pack 400′ as shown to prevent the charge cord 560 and the connector 570 from protruding or dangling when not in use. Similar to the connector 470, the connector 570 can be designed to nest within at least one of the housing 510 or the recess or cavity 512 in various ways such as by at least one of a press-fit or magnetic fit design and components as described with reference to FIGS. 4A-4E.

The headlamp battery pack 400′ on the headlamp 500 in the example shown further includes a cover 514 that can be movably coupled to the housing 510. Similar to the cover 414, the cover 514 can be designed as an integral or modular component on the housing 510 that can be manipulated to at least partly overlap, cover, conceal, and protect the connector 570 when the cover 514 is in a closed position and reveal the connector 570 when the cover 514 is in an open position.

The headlamp battery pack 400′ on the headlamp 500 in the example shown further includes a strap attachment mechanism 516 that can be used to couple at least one of the headlamp battery pack 400′ or the headlamp 500 to a headlamp strap 518 as illustrated. The strap attachment mechanism 516 can be at least partly embodied as or otherwise include at least one of clips, hooks, or other types of fasteners that can securely attach one or both of the headlamp battery pack 400′ or the headlamp 500 to the headlamp strap 518. The strap attachment mechanism 516 can be embodied to allow for easy attachment and detachment of the headlamp battery pack 400′ or the headlamp 500, providing convenience and flexibility for a user. The headlamp strap 518 can be embodied and used to secure at least one of the headlamp battery pack 400′ or the headlamp 500 to a user's head. The headlamp strap 518 can be adjustable to fit different head sizes and can be made from a comfortable and durable material. The headlamp strap 518 can be at least partly embodied as or otherwise include one or more of a buckle, a clasp, or another type of fastener for securing the headlamp strap 518 around a user's head. The headlamp strap 518 can be removable in some cases to allow a user to detach the headlamp strap 518 from the housing 510 when not in use.

Similar to the headlamp battery pack 400, the headlamp battery pack 400′ on the headlamp 500 can be embodied to receive and provide power through the retractable charge cord assembly 550 at least in part by way of the charge cord 560, the connector 570, and the circuit board 590 to charge the power source or battery 592 in some cases or an external device in other cases as described herein with reference to FIGS. 4A-4D. The headlamp battery pack 400′ can serve as a power source for the headlamp unit 500′ in some examples and can be charged by an external power source in other examples.

The circuit board 590 in some examples can be at least partly embodied as or include at least one of a PCB, a microcontroller, an ASIC, or another type of circuit board. The power source or battery 592 can be at least partly integrated or otherwise positioned within the housing 510 on the headlamp battery pack 400′ in the example shown. The power source or battery 592 can be at least partly embodied and implemented as a rechargeable battery or a set of batteries that provide power to the headlamp unit 500′ in some cases. The power source or battery 592 can be electrically coupled to the retractable charge cord assembly 550, which can also be at least partly integrated or otherwise positioned within the housing 510 on the headlamp battery pack 400′ in the example shown.

Similar to the headlamp battery pack 400, the power source or battery 592 in the headlamp battery pack 400′ can be coupled to the retractable charge cord assembly 550 at least in part by way of the circuit board 590 in the example shown. For instance, the retractable charge cord assembly 550 can be coupled to the circuit board 590 and the circuit board 590 can be coupled to the power source or battery 592. The retractable charge cord assembly 550 can further include a power transfer pathway that allows power to flow between the power source or battery 592 in the headlamp battery pack 400′ and at least one of the headlamp unit 500′ or an external device at least in part by way of the connector 570, the charge cord 560, and the circuit board 590. Similar to the headlamp battery pack 400, the direction of power flow through the headlamp battery pack 400′ can be controlled in some cases at least in part by way of a switch (e.g., mechanical, electrical), a controller, or other control mechanism that can be positioned within the headlamp battery pack 400′.

Similar to the retraction mechanism 480 on the headlamp battery pack 400, the retraction mechanism 580 on the headlamp battery pack 400′ in some cases can include a multitude of catches or stops (e.g., integrated notches, detents, or ratchet-like mechanisms) that provide predetermined discrete lengths (e.g., 1 in, 3 in, 6 in) or extension points to which the charge cord 560 can be extended relative to the housing 510. The discrete lengths or extension points can be marked or indicated on the housing 510 in some examples. In some cases, the retraction mechanism 580 can also incorporate a force-sensitive release feature that can cause the charge cord 560 to disengage from a current catch or stop position and retract to a subsequent stop position and discrete length when the charge cord 560 is in an extended position and is tugged with a force beyond a predetermined threshold.

Similar to the headlamp battery pack 400, the power transfer from the charge cord 560 to the circuit board 590 in this example and subsequently to the power source or battery 592 in the headlamp battery pack 400′ for charging can be accomplished in some cases through a series of electrical connections and components. For instance, the charge cord 560 can be embodied at least in part as or include conductive wires that carry electrical current from an external power source. These wires can terminate at contact points within the housing 510 on the headlamp battery pack 400′, where they can connect to the circuit board 590.

Similar to the circuit board 490, the circuit board 590 can serve as a central hub for power management within the headlamp battery pack 400′ in some examples. For instance, the circuit board 590 can include power regulation components (e.g., voltage regulators, current limiters, charge controllers) to ensure incoming power is appropriately conditioned for charging the power source or battery 592.

In some examples, the circuit board 590 can further include protective circuitry designed to prevent damage from voltage spikes or reverse polarity. In other examples, the circuit board 590 can also include a dedicated charging integrated circuit (IC) that can manage the charging process while monitoring factors such as voltage, current, and temperature to optimize battery charging and protect against overcharging of the power source or battery 592 or an external power source. For instance, the circuit board 590 can include overvoltage protection circuits that can prevent excessive voltage from damaging the power source or battery 592 and the headlamp unit 500′ or the light source 520. Similarly, the circuit board 590 can include short-circuit protection circuits that prevent damage in the event of a short circuit in the charge cord 560 or a connected device.

From the circuit board 590, the regulated power can be directed to the power source or battery 592 through additional conductive pathways in some examples. These pathways can be at least partly embodied as or include traces formed on the circuit board 590 itself, as well as wires or other conductive elements that connect the circuit board 590 to terminals on the power source or battery 592. In some embodiments, the circuit board 590 can include sensing circuits that can monitor battery charge state and adjust charging parameters accordingly.

The circuit board 590 in some examples can further include one or more additional components, circuitry, circuit boards, or functionality related to power management. For instance, the circuit board 590 can be embodied such that it can control power distribution to other components on, in, or coupled to the headlamp battery pack 400′, such as a light source on a headlamp that can be coupled to the headlamp battery pack 400′ or any additional features like display screens or secondary lighting elements in some cases. The circuit board 590 can also be embodied such that it can manage power output when the headlamp battery pack 400′ is used as a power bank to charge external devices.

By centralizing power management through the circuit board 590, the headlamp battery pack 400′ design can achieve efficient and controlled charging of the power source or battery 592 or an external power source while also enabling additional features and protections. This arrangement can allow for a compact and integrated power system within the constraints of the headlamp battery pack's 400′ form factor.

In some cases, the retractable charge cord assembly 550 or one or more components thereof and the power source or battery 592 can be located in separate locations on the headlamp 500. For example, the charge cord 560 can be nested in a different portion of the headlamp battery pack 400′, like a rear or back side of the headlamp battery pack 400′, and the power source or battery 592 can be positioned elsewhere, like in the headlamp unit 500′. In such cases, power will need to be efficiently transmitted from the charge cord 560 to the power source or battery 592. This can be achieved through the use of conductive pathways, wires, or other components that can facilitate power transfer between the charge cord 560, the circuit board 590, and the power source or battery 592.

Referring to FIG. 5F, the headlamp 500 is shown with the charge cord 560 on the retractable charge cord assembly 550 in various states of extension. The charge cord 560 can be extended to different lengths and locked in place to meet various user needs as described in examples herein. For instance, the charge cord 560 can be configured to lock at different extension lengths, which can be implemented through various mechanical means, such as notches, detents, or ratchet-like mechanisms integrated into the retraction mechanism 580 in some cases.

The charge cord 560 can be designed to lock after every X number of spool turns in some examples. For instance, if the charge cord 560 catches after every full turn and is pulled for 1.5 turns, the wheel or spool 582 can retract to one turn, leaving one turn's worth of the charge cord 560 extended if a user does not want to use the full length. This feature provides flexibility in how much of the charge cord 560 is extended, allowing users to adjust the length of the charge cord 560 as needed. The charge cord 560 can also be designed to catch when it is pulled to its full length. This feature can allow the entire length of the charge cord 560 to be utilized without retracting, providing maximum extension for charging or power transfer purposes. This full extension feature can be particularly useful when the headlamp battery pack 400′ is used to charge an external device, as it allows for greater reach and flexibility in positioning the headlamp battery pack 400′ relative to the external device.

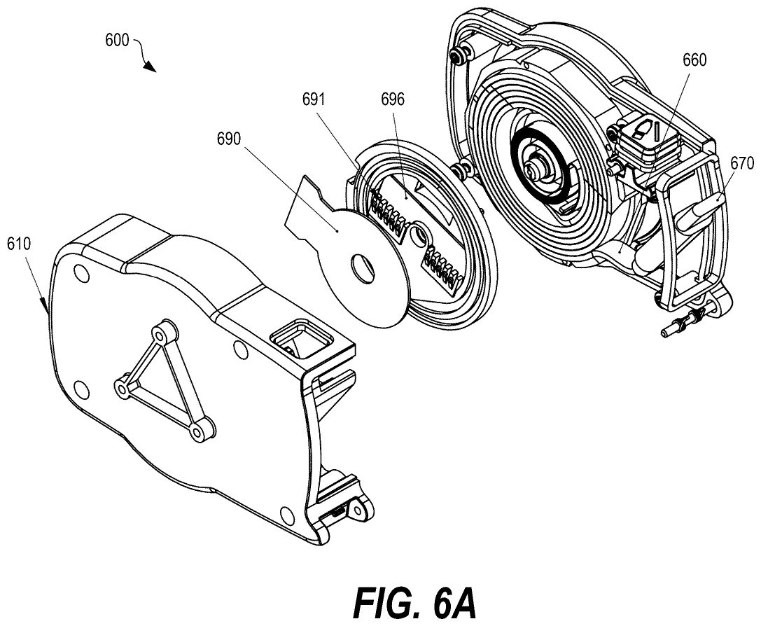

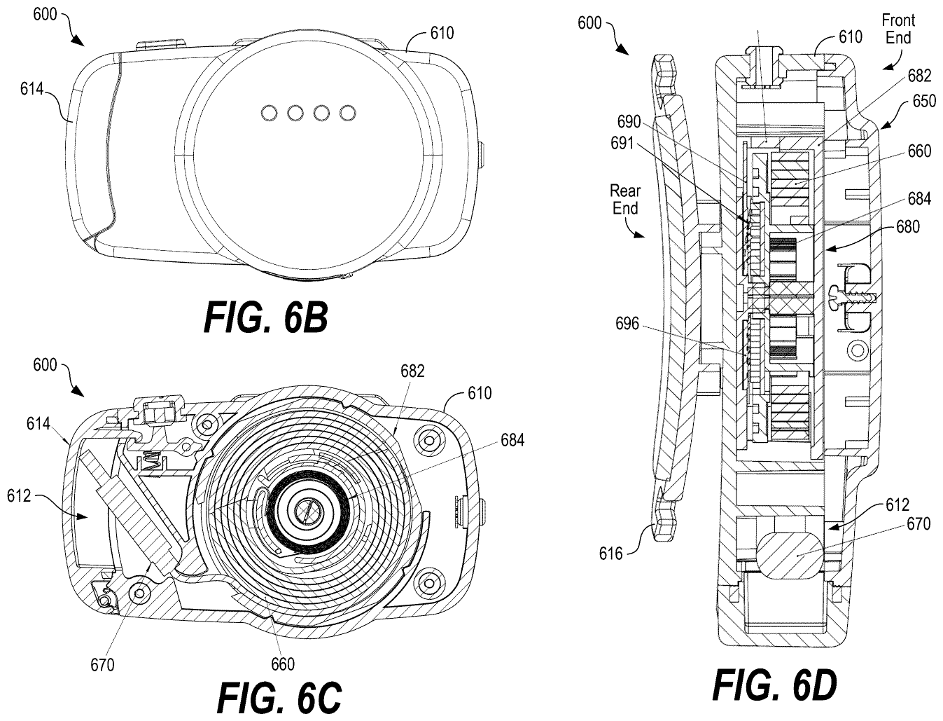

FIGS. 6A to 6D collectively illustrate different views of another example lighting device or headlamp battery pack 600 according to various aspects and embodiments of the present disclosure. In particular, FIG. 6A illustrates an exploded perspective view of the headlamp battery pack 600 with certain components removed from view according to various aspects and embodiments of the present disclosure. FIG. 6B illustrates a front view of the headlamp battery pack 600 according to various aspects and embodiments of the present disclosure. FIGS. 6C and 6D illustrate a cross-sectional front and side view, respectively, of the headlamp battery pack 600 according to various aspects and embodiments of the present disclosure.

The headlamp battery pack 600 is an example alternative embodiment of the headlamp battery pack 400 described herein and illustrated in FIGS. 4A-4E. For instance, the headlamp battery pack 600 can include and implement one or more of the same or similar components, structure, attributes, features, or functions of the headlamp battery pack 400 described herein with reference to FIGS. 4A-4E. The headlamp battery pack 600 is illustrated as another representative example of a multi-functional, self-contained, and portable or wearable lighting device battery pack that can function as a power source for its own corresponding lighting device such as headlamp and other devices external to the headlamp battery pack 600.

The headlamp battery pack 600 is not drawn to any particular scale or size in the drawings. The shape, size, proportion, and other characteristics of the headlamp battery pack 600 and the components thereof can vary as compared to that shown. For example, the headlamp battery pack 600 can accommodate different retractable charge cord assembly components, configurations, and locations, and other variations are within the scope of the examples described herein. Additionally, one or more of the parts or components of the headlamp battery pack 600, as illustrated in the drawings and described herein, can be omitted in some cases. The headlamp battery pack 600 can also include other parts or components that are not illustrated.

Among other components, the headlamp battery pack 600 shown in FIGS. 6A-6D includes a housing 610, a retractable charge cord assembly 650, a stationary circuit board 690, a power source or battery 692, an internal power management system 694, and a rotating circuit board 696 in this example. The housing 610 can be constructed from a variety of materials, such as plastic, metal, or a combination thereof, and can be designed to be durable and resistant to environmental factors such as water, dust, and impacts.

The retractable charge cord assembly 650 includes a charge cord 660, a connector 670 coupled to an end of the charge cord 660, and a retraction mechanism 680 configured to extend and retract the charge cord 660 and the connector 670 in this example. The retraction mechanism 680 can be at least partly embodied as or otherwise include a wheel or spool structure 682 around which the charge cord 660 can be wound, and a spring or spring-like mechanism or system 684 that can facilitate automatic retraction of the charge cord 660 and the connector 670 when not in use as shown in this example.

Referring to FIGS. 6C and 6D, the wheel or spool 682 can have a circular geometry or shape and it can be embodied and implemented to rotate or spin, facilitating the extension and retraction of the charge cord 660 in some cases. The wheel or spool 682 can be housed within a compartment or casing 686 within the housing 610 of the headlamp battery pack 600 as shown in this example to provide protection and containment for the charge cord 660 when it is not in use.

The spring mechanism 684 is coupled to the wheel or spool 682 in the example shown. The spring mechanism 684 can be embodied, configured, and implemented in this example to apply a force or tension to the wheel or spool 682, causing the wheel or spool 682 to spin or rotate in a direction that retracts the charge cord 660. The retraction mechanism 680 in some cases can include a multitude of catches or stops (e.g., notches, detents, ratchet-like mechanisms) that provide discrete lengths of the charge cord 660 as extended relative to the housing 610, such as 1 inch, 3 inches, 6 inches, and so forth. The retraction mechanism 680 can be designed to allow users to easily extend the charge cord 660 to a desired length and have it lock into place at these predetermined points, which can be marked or indicated on the housing 610 in some examples. The retraction mechanism 680 can also incorporate a force-sensitive release feature in some cases. When the charge cord 660 is in an extended position and is tugged with a force beyond a predetermined threshold, it can cause the charge cord 660 to disengage from its current catch or stop position and retract to a subsequent stop position and discrete length.

The connector 670 in many cases can be at least partly embodied and implemented as a USB connector, a micro-USB connector, a USB-C connector, or any other type of connector suitable for transmitting power. The connector 670 can be nested on or within a portion of the housing 610 when the charge cord 660 is fully retracted in the example shown. For instance, the connector 670 can be designed to fit snugly within a recess or cavity 612 in the housing 610 as shown to prevent the charge cord 660 and the connector 670 from protruding or dangling when not in use. The connector 670 can be designed to nest within at least one of the housing 610 or the recess or cavity 612 in various ways such as by at least one of a press-fit or magnetic fit design and components as described in examples herein with reference to FIGS. 4A-4E.

The headlamp battery pack 600 in the example shown further includes a cover 614 that can be movably coupled to the housing 610. The cover 614 can be designed to at least partly overlap, cover, and conceal the connector 670 when the cover 614 is in a closed position. The cover 614 can be embodied as a separate component that can be attached to the housing 610 in some cases, or the cover 614 can be an integral part of the housing 610 that can be manipulated to reveal or conceal the connector 670 in other cases. The cover 614 can be designed to move in various ways, such as at least one of sliding, pivoting, or rotating, to reveal the connector 670 in some examples. The cover 614 in some cases can include one or more of a latch, a catch, or another type of locking mechanism that secures the cover 614 in the closed position, helping to protect the connector 670 and charge cord 660 from environmental factors.

The headlamp battery pack 600 in the example shown further includes a strap attachment mechanism 616 that can be used to couple the headlamp battery pack 600 to a headlamp strap (not illustrated). The strap attachment mechanism 616 can include at least one of clips, hooks, or other types of fasteners that can securely attach the headlamp battery pack 600 to a headlamp strap. The strap attachment mechanism 616 can be embodied to allow for easy attachment and detachment of the headlamp battery pack 600, providing convenience and flexibility for a user.

One or both of the stationary circuit board 690 or the rotating circuit board 696 in the example shown can be at least partly embodied as or include at least one of a PCB, a microcontroller, an ASIC, or another type of circuit board. The power source or battery 692 can be positioned within the housing 610 and coupled to the retractable charge cord assembly 650 at least in part by way of the stationary circuit board 690 in the example shown. For instance, the retractable charge cord assembly 650 can be coupled to the stationary circuit board 690 and the stationary circuit board 690 can include or be coupled to the power source or battery 692.

The retractable charge cord assembly 650 can further include a power transfer pathway that allows power to flow from an external power source (not illustrated), through the charge cord 660, to the power source or battery 692 in the headlamp battery pack 600. This power transfer pathway can be facilitated by electrical connections or conductive materials within the charge cord 660 and the headlamp battery pack 600. The power transfer pathway can allow the headlamp battery pack 600 to be charged from an external power source, such as a wall outlet or a USB port on a computer or other electronic device.

The retractable charge cord assembly 650 can also be designed to allow power to flow in an opposite direction out of the headlamp battery pack 600, from the power source or battery 692, through the charge cord 660, to an external device. This feature can allow the headlamp battery pack 600 to serve as a power source or power bank for charging other electronic devices, such as mobile phones, tablets, or other portable lighting devices. The direction of power flow can be controlled in some cases at least in part by way of a switch, a controller, or other control mechanism that can be positioned within the headlamp battery pack 600.

The retractable charge cord assembly 650 can be at least partly integrated with the housing 610 such as onto an external portion or into an internal portion of the housing 610 in various examples. The retractable charge cord assembly 650 in the example shown is at least partly integrated within the housing 610. The retractable charge cord assembly 650, including the retraction mechanism 680 and the aforementioned power transfer pathway, can be at least partly integrated with or positioned at least partly within the housing 610 on the headlamp battery pack 600 in a way that maintains compactness and portability of the headlamp battery pack 600. The retractable charge cord assembly 650 can be designed to fit within the confines of the housing 610 in some cases without significantly increasing the size or weight of the headlamp battery pack 600 relative to a reference size or weight of the headlamp battery pack 600 without the retractable charge cord assembly 650. The integration of the retractable charge cord assembly 650 into the headlamp battery pack 600 as shown in this example provides a self-contained, all-in-one solution for lighting and charging needs, enhancing the convenience and versatility of the headlamp battery pack 600.

The power transfer from the charge cord 660 to the rotating circuit board 696, then to the stationary circuit board 690, and subsequently to the power source or battery 692 in the headlamp battery pack 600 for charging can be accomplished in some cases through a series of electrical connections and components. The charge cord 660 can be embodied at least in part as or include conductive wires that can carry electrical current from an external power source. These wires in the charge cord 660 can terminate at contact points on the rotating circuit board 696 within the housing 610. For instance, in some cases the wires in the charge cord 660 can terminate at leaf-spring connectors 691 on the rotating circuit board 696 that maintain electrical connection or coupling of the stationary circuit board 690 and the rotating circuit board 696.

The stationary circuit board 690 can serve as a central hub for power management within the headlamp battery pack 600 at least in part by way of the internal power management system 694 in some examples. For instance, the stationary circuit board 690 can include power regulation components such as at least one of voltage regulators, current limiters, or charge controllers in some cases. The internal power management system 694 can use such components to ensure incoming power is appropriately conditioned for charging the power source or battery 692.

When power flows from the charge cord 660 to the stationary circuit board 690 in some cases, it can first pass through protective circuitry designed to prevent damage from voltage spikes or reverse polarity. The stationary circuit board 690 can process and regulate such incoming power in some examples. The stationary circuit board 690 in some cases can include a dedicated charging integrated circuit (IC) that can manage the charging process while monitoring factors such as voltage, current, and temperature to optimize battery charging and protect against overcharging of the power source or battery 692 or an external power source.

From the stationary circuit board 690, the regulated power can be directed to the power source or battery 692 through additional conductive pathways such as wires 693 in some examples. The wires 693 can be at least partly embodied as or include traces formed on the stationary circuit board 690 itself, as well as wires or other conductive elements that connect the stationary circuit board 690 to terminals on the power source or battery 692. In some embodiments, the stationary circuit board 690 can include sensing circuits that can be used by the internal power management system 694 to monitor battery charge state and adjust charging parameters accordingly.

The stationary circuit board 690 in some examples can further include one or more additional components, circuitry, circuit boards, or functionality related to power management. For instance, the stationary circuit board 690 can be embodied such that the internal power management system 694 can control power distribution to other components on or in the headlamp battery pack 600, such as the light source 620 or any additional features like display screens or secondary lighting elements in some cases. The stationary circuit board 690 can also be embodied such that the internal power management system 694 can manage power output when the headlamp battery pack 600 is used as a power bank to charge external devices.

By centralizing power management through the stationary circuit board 690 and the internal power management system 694, the headlamp battery pack 600 design can achieve efficient and controlled charging of the power source or battery 692 or an external power source while also enabling additional features and protections. This arrangement can allow for a compact and integrated power system within the constraints of the headlamp battery pack's 600 form factor.

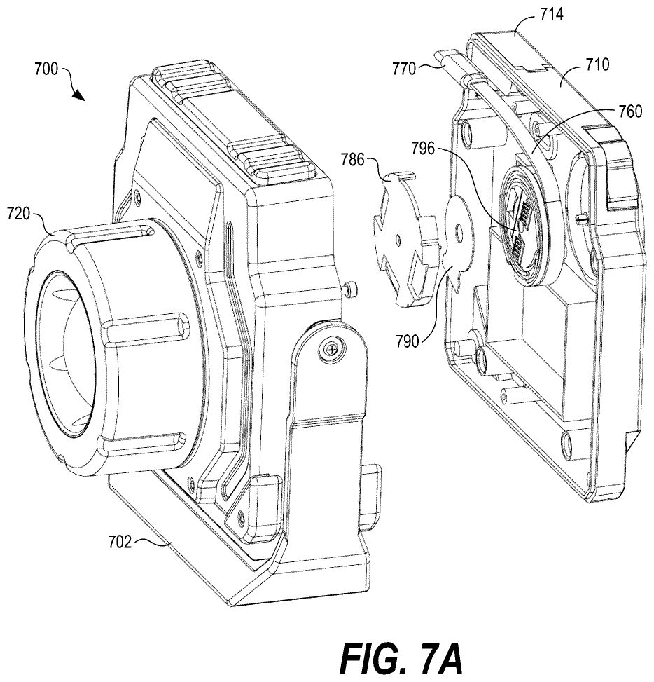

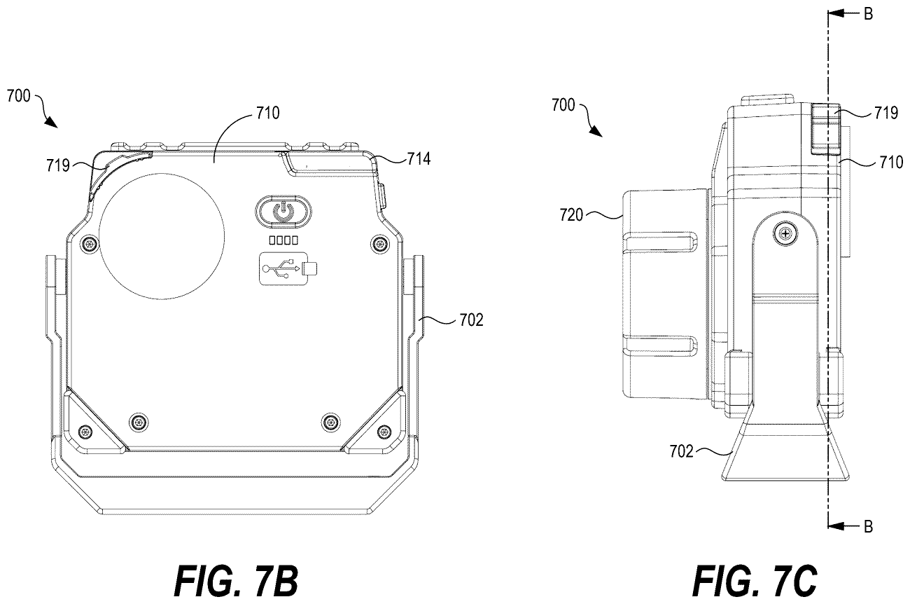

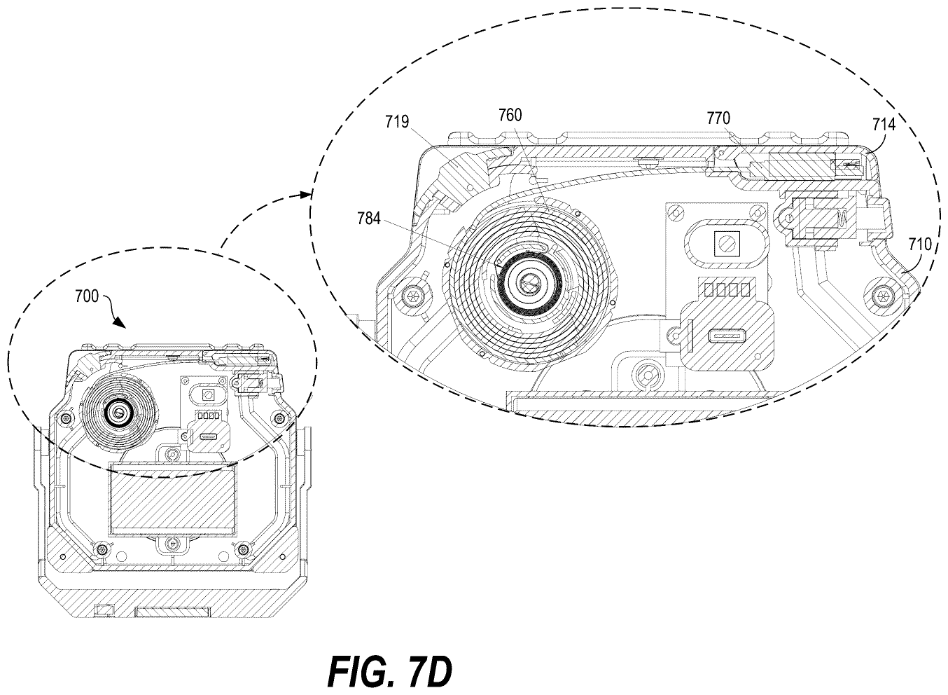

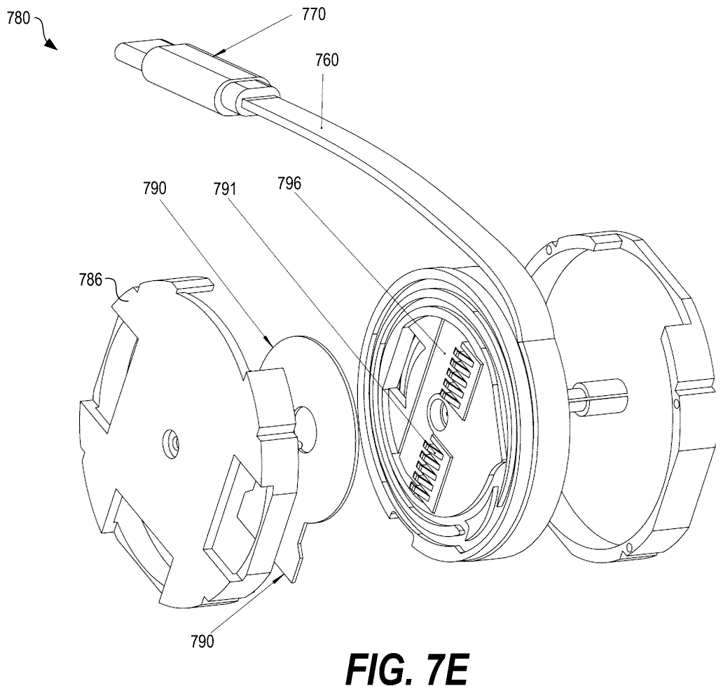

FIGS. 7A to 7E collectively illustrate different views of an example lighting device or worklight 700 according to various aspects and embodiments of the present disclosure. In particular, FIG. 7A illustrates an exploded perspective view of the worklight 700 according to various aspects and embodiments of the present disclosure. FIGS. 7B and 7C illustrate a rear view and a side view, respectively, of the worklight 700 according to various aspects and embodiments of the present disclosure. FIG. 7D illustrates a cross-sectional rear view of the worklight 700 designated B-B in FIG. 7C according to various aspects and embodiments of the present disclosure. FIG. 7E illustrates an exploded perspective view of an example retraction mechanism 780 on the worklight 700 according to various aspects and embodiments of the present disclosure.

The worklight 700 is illustrated as a representative example of a multi-functional, self-contained, and portable or hand-held lighting device that can function as both a worklight and a power source for itself and other devices external to the worklight 700. The concepts described herein can be extended to use with a range of lighting devices of different types, styles, components, and configurations, however. The worklight 700 includes a power source such as a battery that can be coupled to and charged by a retractable charge cord assembly. The battery can then be used to power the worklight 700 or another device external to the worklight 700, thereby eliminating the need for separate charging cables or docking stations and providing significant advantages in convenience, portability, versatility, and utility compared to existing portable or rechargeable flashlights. These features and others described in examples herein allow the worklight 700 to be suitable for use in a variety of challenging environments.

The worklight 700 is not drawn to any particular scale or size in the drawings. The shape, size, proportion, and other characteristics of the worklight 700 and the components thereof can vary as compared to that shown. For example, the worklight 700 can accommodate different retractable charge cord assembly components, configurations, and locations, and other variations are within the scope of the examples described herein. Additionally, one or more of the parts or components of the worklight 700, as illustrated in the drawings and described herein, can be omitted in some cases. The worklight 700 can also include other parts or components that are not illustrated.

Among other components, the worklight 700 shown in FIGS. 7A-7D includes a housing 710, which can be constructed from a variety of materials, such as plastic, metal, or a combination thereof. The housing 710 can be designed to be durable and resistant to environmental factors such as water, dust, and impacts. Within the housing 710, a light source 720 is disposed in the example shown. The light source 720 can be any suitable type of light-emitting element, such as an LED, an incandescent bulb, or a halogen bulb, among others. The light source 720 can be configured to emit light when powered, providing illumination for a user of the worklight 700.

The worklight 700 further includes a retractable charge cord assembly 750, a stationary circuit board 790, a power source or battery 792, an internal power management system 794, and a rotating circuit board 796 disposed within the housing 710 and electrically coupled to the light source 720 in the example shown. The power source 792 can be a rechargeable battery or a set of batteries that provide power to the worklight 700. The power source or battery 792 can be electrically coupled to the retractable charge cord assembly 750, which can be at least partly integrated with the housing 710 such as onto an external portion or into an internal portion of the housing 710 in various examples. The retractable charge cord assembly 750 in the example shown is at least partly integrated within the housing 710.

The retractable charge cord assembly 750 in the example shown is an example alternative embodiment of the retractable charge cord assembly 650 described herein and illustrated in FIGS. 6A-6D. For instance, the retractable charge cord assembly 750 can include and implement one or more of the same or similar components, structure, attributes, features, or functions of the retractable charge cord assembly 650 described herein with reference to FIGS. 6A-6D.

The retractable charge cord assembly 750 includes a charge cord 760, a connector 770 coupled to an end of the charge cord 760, and a retraction mechanism 780 configured to extend and retract the charge cord 760. The retraction mechanism 780 can be located at a convenient location on the worklight 700, such as an upper side away from a base 702 as shown in this example to provide easy access for a user. However, other locations on the worklight 700 can be employed. The retractable charge cord assembly 750 allows the worklight 700 to be charged from an external power source, and in some cases, can also allow the worklight 700 to serve as a power source for charging other devices as described in other examples herein.

The connector 770 at the end of the charge cord 760 can be configured to nest on or within a portion of the housing 710 when the charge cord 760 is fully retracted. This nesting feature can help protect the connector 770 from damage and can also provide a neat and tidy appearance for the worklight 700. The connector 770 can be designed to fit snugly within a recess or cavity 712 in the housing 710, preventing it from protruding or dangling when not in use. The nesting feature can also prevent the connector 770 from interfering with the operation of the worklight 700 or becoming entangled with other objects.

The worklight 700 can further include a cover 714 movably coupled to the housing 710. The cover 714 can be designed to conceal the connector 770 when in a closed position. The cover 714 can be a separate component that is attached to the housing 710, or it can be an integral part of the housing 710 that can be manipulated to reveal or conceal the connector 770. The cover 714 can be designed to move in various ways, such as sliding, pivoting, or rotating, to reveal the connector 770. The cover 714 can be embodied as or otherwise include a latch, a catch, or another type of locking mechanism that secures it in a closed position, helping to protect the connector 770 and charge cord 760 from environmental factors.

The retraction mechanism 780 can include a wheel or spool 782 around which the charge cord 760 is wound in the example shown. The wheel or spool 782 can be circular in shape in this example and can be designed to rotate or spin, facilitating the extension and retraction of the charge cord 760. The wheel or spool 782 can be housed within a compartment or casing 786 within the housing 710 of the worklight 700, providing protection and containment for the charge cord 760 when it is not in use.

The spring mechanism 784 can be configured to apply a force or tension to the wheel or spool 782, causing it to spin or rotate in a direction that retracts the charge cord 760. This automatic retraction feature can provide convenience for a user and can help to keep the charge cord 760 neatly stored within the housing 710 of the worklight 700 when not in use. The charge cord 760 can be designed to lock at different extension lengths in some examples. This feature can be implemented through various mechanical means, such as notches, detents, or ratchet-like mechanisms that can be integrated into the retraction mechanism 780 in some cases. These locking features can provide a secure and reliable way to maintain the charge cord 760 at a desired extension length, while also allowing for easy adjustment when needed.

One or both of the stationary circuit board 790 or the rotating circuit board 796 in the example shown can be at least partly embodied as or include at least one of a PCB, a microcontroller, an ASIC, or another type of circuit board. The power source or battery 792 can be positioned within the housing 710 and coupled to the retractable charge cord assembly 750 at least in part by way of the stationary circuit board 790 in the example shown. For instance, the retractable charge cord assembly 750 can be coupled to the stationary circuit board 790 and the stationary circuit board 790 can include or be coupled to the power source or battery 792.

The retractable charge cord assembly 750 can further include a power transfer pathway that allows power to flow from an external power source (not illustrated), through the charge cord 760, to the power source or battery 792 in the work light 700. This power transfer pathway can be facilitated by electrical connections or conductive materials within the charge cord 760 and the worklight 700. The power transfer pathway can allow the worklight 700 to be charged from an external power source, such as a wall outlet or a USB port on a computer or other electronic device.

The power transmission path within the worklight 700 can be designed to efficiently transmit power between the charge cord 760, the rotating circuit board 796, the stationary circuit board 790, and the power source or battery 792 in the worklight 700. The charge cord 760 can be electrically coupled to the stationary circuit board 790, allowing power to flow from an external power source, through the charge cord 760, to the stationary circuit board 790. The stationary circuit board 790 can include various electronic components and circuitry designed to regulate and control power flow within the worklight 700. For instance, the stationary circuit board 790 can include voltage regulators, current limiters, or charge controllers that can condition the incoming power from the charge cord 760 to ensure safe and efficient charging of the power source or battery 792. From the stationary circuit board 790, the regulated power can be directed to the power source or battery 792 through additional conductive pathways. These pathways can include traces on the stationary circuit board 790 itself, as well as wires or other conductive elements that connect the stationary circuit board 790 to battery terminals on the power source or battery 792. In some embodiments, the stationary circuit board 790 can include and implement sensing circuits that can monitor a battery's charge state and adjust charging parameters accordingly.

The stationary circuit board 790 can also manage power output when the worklight 700 is used to charge external devices. For instance, the stationary circuit board 790 can include circuitry that allows power to flow from the power source or battery 792, through the stationary circuit board 790, and out through the charge cord 760 to an external device. This feature can allow the worklight 700 to serve as a power bank, providing a convenient power source for charging other electronic devices such as mobile phones, tablets, or other portable lighting devices. The stationary circuit board 790 can further include protective circuitry in some cases designed to prevent damage to the worklight 700 and connected devices. For instance, the stationary circuit board 790 can include overvoltage protection circuits that prevent excessive voltage from damaging the power source or battery 792 and the light source 720. Similarly, the stationary circuit board 790 can include short-circuit protection circuits that can prevent damage in the event of a short circuit in the charge cord 760 and a connected device. The worklight 700 can also include a switch (not shown) or other control mechanism in some examples that allows a user to select whether to charge the power source or battery 792 or an external device. This switch can be physically located on the housing 710 of the worklight 700, or it can be an electronic switch controlled by the stationary circuit board 790. The stationary circuit board 790 can further include circuitry in some examples that detects the switch position and directs power flow accordingly.

The retractable charge cord assembly 750 can also be designed to allow power to flow in an opposite direction out of the worklight 700, from the power source or battery 792, through the charge cord 760, to an external device. This feature can allow the worklight 700 to serve as a power source or power bank for charging other electronic devices, such as mobile phones, tablets, or other portable lighting devices. The direction of power flow can be controlled in some cases at least in part by way of a switch, a controller, or other control mechanism that can be positioned within the worklight 700.

The power transfer from the charge cord 760 to the rotating circuit board 796, then to the stationary circuit board 790, and subsequently to the power source or battery 792 in the worklight 700 for charging can be accomplished in some cases through a series of electrical connections and components. The charge cord 760 can be embodied at least in part as or include conductive wires that can carry electrical current from an external power source. These wires in the charge cord 760 can terminate at contact points on the rotating circuit board 796 within the housing 710. For instance, in some cases the wires in the charge cord 760 can terminate at leaf-spring connectors 791 on the rotating circuit board 796 that maintain electrical connection or coupling of the stationary circuit board 790 and the rotating circuit board 796.

The stationary circuit board 790 can serve as a central hub for power management within the worklight 700 at least in part by way of the internal power management system 794 in some examples. For instance, the stationary circuit board 790 can include power regulation components such as at least one of voltage regulators, current limiters, or charge controllers in some cases. The internal power management system 794 can use such components to ensure incoming power is appropriately conditioned for charging the power source or battery 792.

When power flows from the charge cord 760 to the stationary circuit board 790 in some cases, it can first pass through protective circuitry designed to prevent damage from voltage spikes or reverse polarity. The stationary circuit board 790 can process and regulate such incoming power in some examples. The stationary circuit board 790 in some cases can include a dedicated charging integrated circuit (IC) that can manage the charging process while monitoring factors such as voltage, current, and temperature to optimize battery charging and protect against overcharging of the power source or battery 792 or an external power source.

From the stationary circuit board 790, the regulated power can be directed to the power source or battery 792 through additional conductive pathways such as wires 793 in some examples. The wires 793 can be at least partly embodied as or include traces formed on the stationary circuit board 790 itself, as well as wires or other conductive elements that connect the stationary circuit board 790 to terminals on the power source or battery 792. In some embodiments, the stationary circuit board 790 can include sensing circuits that can be used by the internal power management system 794 to monitor battery charge state and adjust charging parameters accordingly.

The stationary circuit board 790 in some examples can further include one or more additional components, circuitry, circuit boards, or functionality related to power management. For instance, the stationary circuit board 790 can be embodied such that the internal power management system 794 can control power distribution to other components on or in the worklight 700, such as the light source 720 or any additional features like display screens or secondary lighting elements in some cases. The stationary circuit board 790 can also be embodied such that the internal power management system 794 can manage power output when the worklight 700 is used as a power bank to charge external devices.

By centralizing power management through the stationary circuit board 790 and the internal power management system 794, the worklight 700 design can achieve efficient and controlled charging of the power source or battery 792 or an external power source while also enabling additional features and protections. This arrangement can allow for a compact and integrated power system within the constraints of the worklight's 700 form factor.

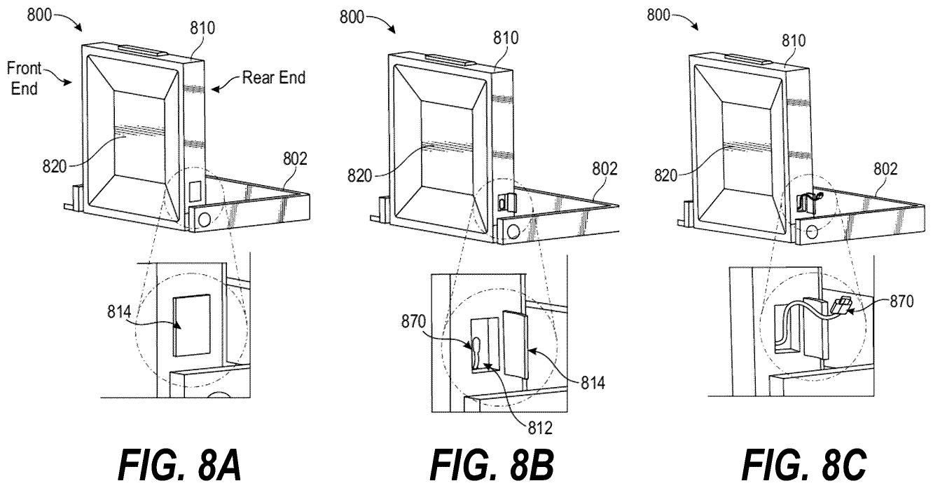

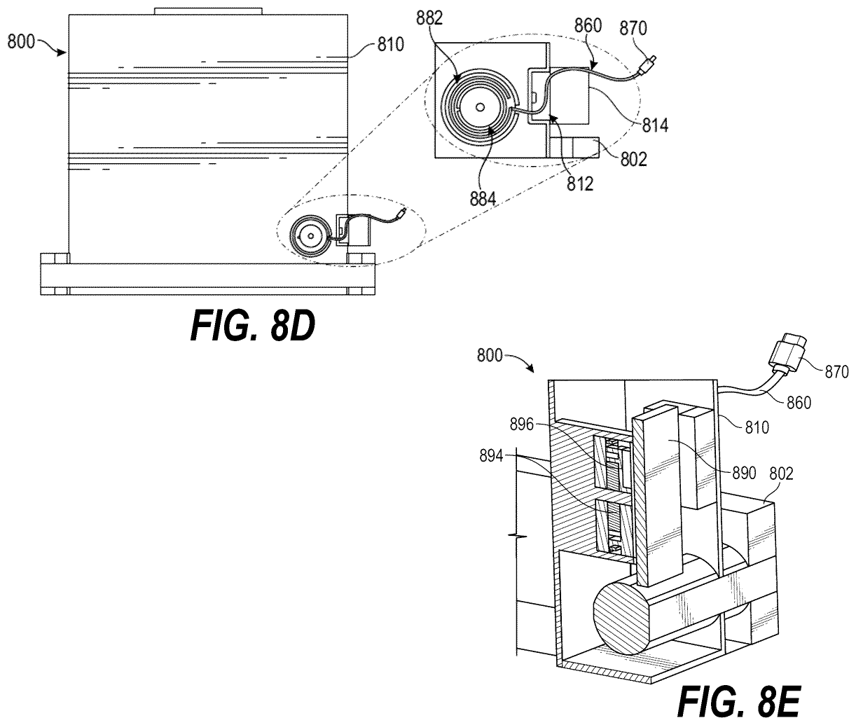

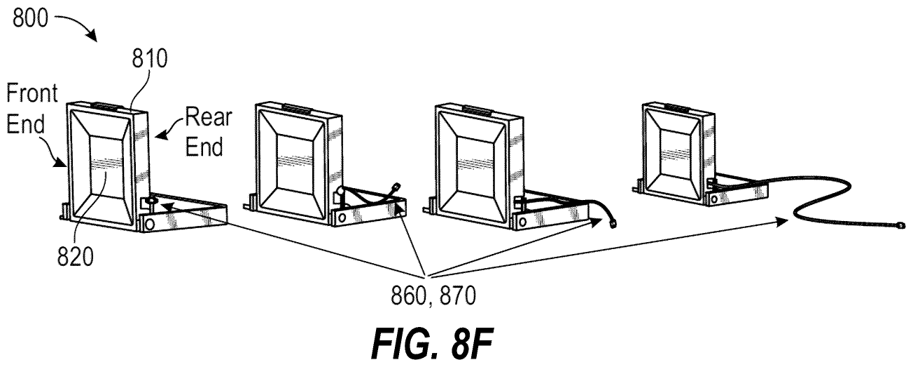

FIGS. 8A to 8F collectively illustrate different views of another example lighting device or worklight 800 according to various aspects and embodiments of the present disclosure. In particular, FIGS. 8A, 8B, and 8C each illustrate a different perspective view of the worklight 800 according to various aspects and embodiments of the present disclosure. In FIGS. 8B and 8C, a cover component on the worklight 800 shown in FIG. 8A is configured in an open position to illustrate another example nesting location of an example connector and charge cord according to one embodiment. FIGS. 8D and 8E illustrate a cross-sectional front and perspective view, respectively, of the worklight 800 according to various aspects and embodiments of the present disclosure. FIG. 8F illustrates example retractable charge cord assembly extension states of the worklight 800 according to various aspects and embodiments of the present disclosure.

The worklight 800 is an example alternative embodiment of the worklight 700 described herein and illustrated in FIGS. 7A-7E. For instance, the worklight 800 can include and implement one or more of the same or similar components, structure, attributes, features, or functions of the worklight 700 described herein with reference to FIGS. 7A-7E. The worklight 800 is illustrated as another representative example of a multi-functional, self-contained, and portable lighting device that can function as a power source for its own lighting source and other devices external to the worklight 800.

The worklight 800 is not drawn to any particular scale or size in the drawings. The shape, size, proportion, and other characteristics of the worklight 800 and the components thereof can vary as compared to that shown. For example, the worklight 800 can accommodate different retractable charge cord assembly components, configurations, and locations, and other variations are within the scope of the examples described herein. Additionally, one or more of the parts or components of the worklight 800, as illustrated in the drawings and described herein, can be omitted in some cases. The worklight 800 can also include other parts or components that are not illustrated.

Among other components, the worklight 800 in the example shown includes a base 802, a housing 810, a light source 820, a retractable charge cord assembly 850, a circuit board 890, and a power source or battery 892. The retractable charge cord assembly 850 includes a charge cord 860, a connector 870 coupled to an end of the charge cord 860, and a retraction mechanism 880 configured to extend and retract the charge cord 860 and the connector 870 in this example. The retraction mechanism 880 can be at least partly embodied as or otherwise include a wheel or spool structure 882 around which the charge cord 860 can be wound, and a spring or spring-like mechanism or system 884 that can facilitate automatic retraction of the charge cord 860 and the connector 870 when not in use as shown in this example.

Referring to FIGS. 8D and 8E, the wheel or spool 882 can have a circular geometry or shape and it can be embodied and implemented to rotate or spin, facilitating the extension and retraction of the charge cord 860 in some cases. The wheel or spool 882 can be housed within a compartment or casing 886 within the housing 810 on the worklight 800 as shown in this example to provide protection and containment for the charge cord 860 when it is not in use. The connector 870 can be designed to fit snugly within a recess or cavity 812 in the housing 810 on the worklight 800 as shown to prevent the charge cord 860 and the connector 870 from protruding or dangling when not in use.

The worklight 800 in the example shown further includes a cover 814 that can be movably coupled to the housing 810. Similar to the cover 714, the cover 814 can be designed as an integral or modular component on the housing 810 that can be manipulated to at least partly overlap, cover, conceal, and protect the connector 870 when the cover 814 is in a closed position and reveal the connector 870 when the cover 814 is in an open position.

The retraction mechanism 880 can be located at various locations on or within the housing 810. In the example shown, the recess or cavity 812, the cover 814, the retraction mechanism 880, the wheel or spool 882, the spring mechanism 884, the compartment or casing 886, and the charge cord 860 are located at a lower side on the housing 810 close to the base 802, which is a convenient location on the worklight 800 that provides a user with easy access to the connector 870 and the charge cord 860.

Referring to FIG. 8F, the worklight 800 is shown with the charge cord 860 on the retractable charge cord assembly 850 in various states of extension. The charge cord 860 can be extended to different lengths and locked in place to meet various user needs as described in examples herein. For instance, the charge cord 860 can be configured to lock at different extension lengths, which can be implemented through various mechanical means, such as notches, detents, or ratchet-like mechanisms integrated into the retraction mechanism 880 in some cases. The charge cord 860 can be designed to lock after every X number of spool turns in some examples. For instance, if the charge cord 860 catches after every full turn and is pulled for 1.5 turns, the wheel or spool 882 can retract to one turn, leaving one turn's worth of the charge cord 860 extended if a user does not want to use the full length. The charge cord 860 can also be designed to catch when it is pulled to its full length.

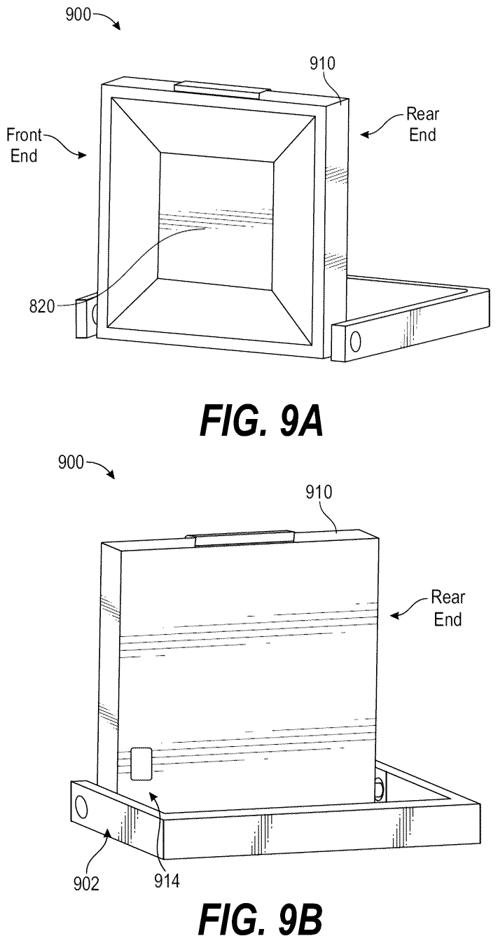

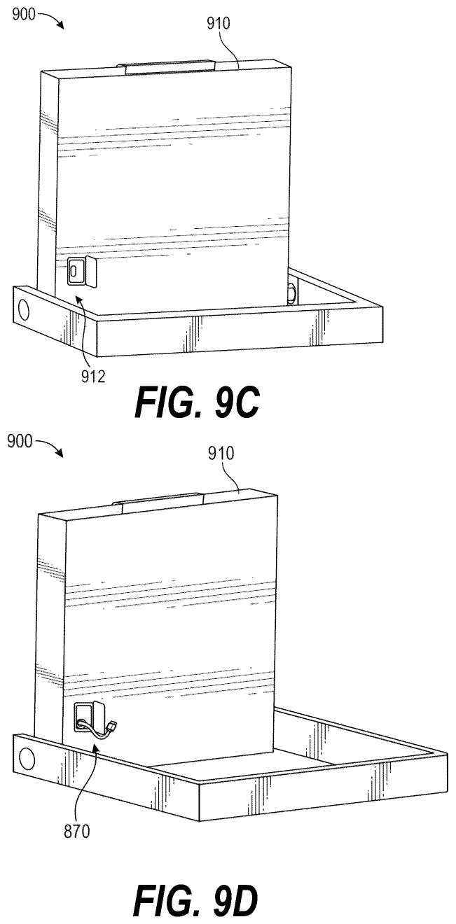

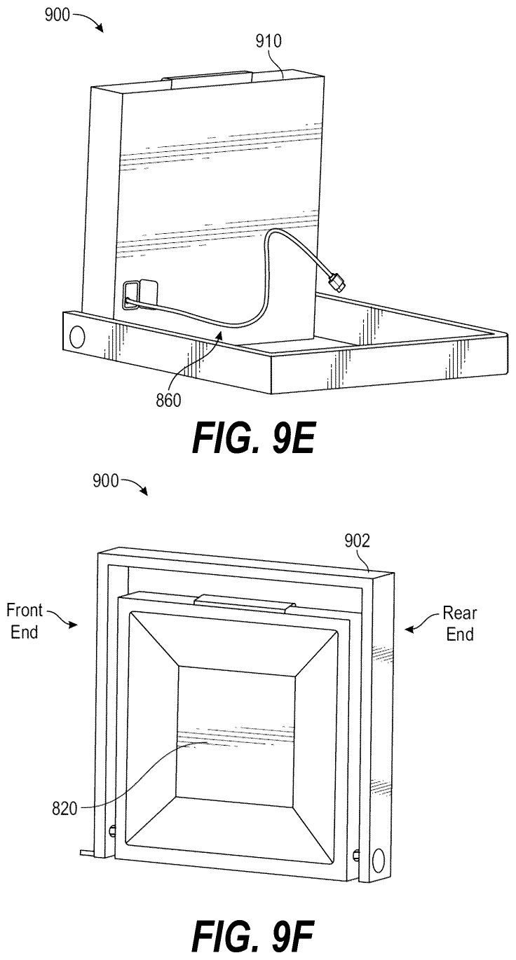

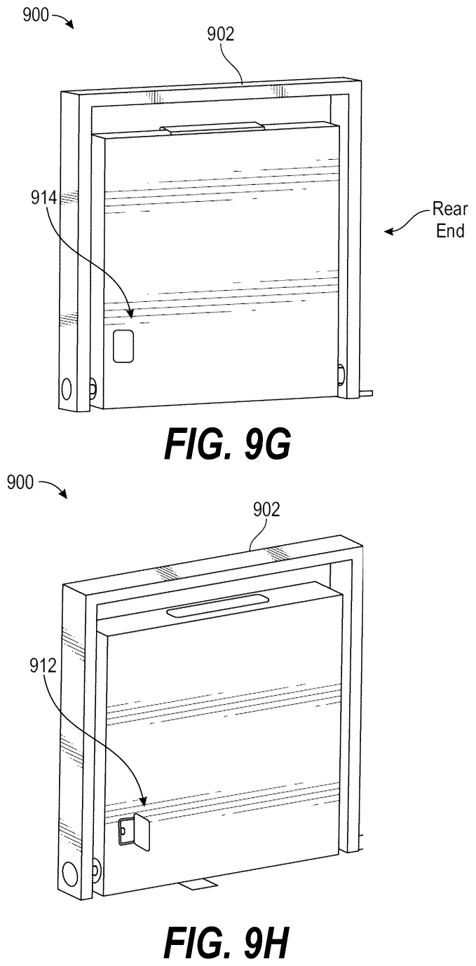

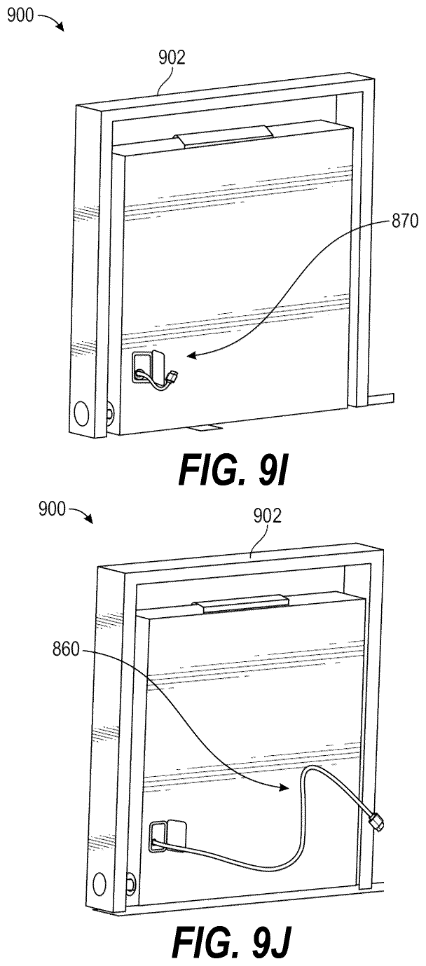

FIGS. 9A to 9J collectively illustrate different views of another example lighting device or worklight 900 according to various aspects and embodiments of the present disclosure. In particular, FIGS. 9A and 9F illustrate different perspective front views of the worklight 900, and FIGS. 9B, 9C, 9D, 9E, 9G, 9H, 9I, and 9J illustrate different perspective rear views of the worklight 900 according to various aspects and embodiments of the present disclosure. In FIGS. 9C, 9D, 9E, 9H, 9I, and 9J, a cover component on the worklight 900 shown in FIG. 9A is configured in an open position to illustrate another example nesting location of an example connector and charge cord according to one embodiment. FIGS. 9D, 9E, 9I, and 9J illustrate example retractable charge cord assembly extension states of the worklight 900 according to various aspects and embodiments of the present disclosure.

The worklight 900 is an example alternative embodiment of the worklight 700 described herein and illustrated in FIGS. 7A-7E. For instance, the worklight 900 can include and implement one or more of the same or similar components, structure, attributes, features, or functions of the worklight 700 described herein with reference to FIGS. 7A-7E. The worklight 900 is illustrated as another representative example of a multi-functional, self-contained, and portable lighting device that can function as a power source for its own lighting source and other devices external to the worklight 900.

The worklight 900 is not drawn to any particular scale or size in the drawings. The shape, size, proportion, and other characteristics of the worklight 900 and the components thereof can vary as compared to that shown. For example, the worklight 900 can accommodate different retractable charge cord assembly components, configurations, and locations, and other variations are within the scope of the examples described herein. Additionally, one or more of the parts or components of the worklight 900, as illustrated in the drawings and described herein, can be omitted in some cases. The worklight 900 can also include other parts or components that are not illustrated.

Among other components, the worklight 900 in the example shown includes a base 902, a housing 910, the light source 820, the retractable charge cord assembly 850, the circuit board 890, and the power source or battery 892. The retractable charge cord assembly 850 includes the charge cord 860, the connector 870 coupled to an end of the charge cord 860, and the retraction mechanism 880 configured to extend and retract the charge cord 860 and the connector 870 in this example. The retraction mechanism 880 can be at least partly embodied as or otherwise include the wheel or spool structure 882 around which the charge cord 860 can be wound, and the spring mechanism 884 to facilitate automatic retraction of the charge cord 860 and the connector 870 when not in use.

The wheel or spool 882 can be housed within a compartment or casing 886 within the housing 910 on the worklight 900 to provide protection and containment for the charge cord 860 when it is not in use. The connector 870 can be designed to fit snugly within a recess or cavity 912 in the housing 910 on the worklight 800 as shown to prevent the charge cord 860 and the connector 870 from protruding or dangling when not in use.

The worklight 900 in the example shown further includes a cover 914 that can be movably coupled to the housing 910. The cover 914 can be designed as an integral or modular component on the housing 910 that can be manipulated to at least partly overlap, cover, conceal, and protect the connector 870 when the cover 914 is in a closed position and reveal the connector 870 when the cover 914 is in an open position.

The retraction mechanism 880 can be located at various locations on or within the housing 910. In the example shown, the recess or cavity 912, the retraction mechanism 880, the wheel or spool 882, the spring mechanism 884, the compartment or casing 886, and the charge cord 860 are located at a lower corner region on the rear end or back of the housing 910 away from the base 902, which is a convenient location on the worklight 900 that provides a user with easy access to the connector 870 and the charge cord 860.

The base 902 on the worklight 900 can be at least partly embodied and implemented as a handle and a stand as shown in FIGS. 9A-9J. The recess or cavity 912, the cover 914, the retraction mechanism 880, the wheel or spool 882, the spring mechanism 884, the compartment or casing 886, and the charge cord 860 are located on the rear end or back of the worklight 900 to ensure they do not interfere with the base 902 or use thereof as a handle or a stand. The location of the recess or cavity 912, the cover 914, the retraction mechanism 880, the wheel or spool 882, the spring mechanism 884, the compartment or casing 886, and the charge cord 860 in this example can allow for easy access to the charge cord 860 while maintaining the functionality of the base 902 as handle or stand. This design can provide a balance between functionality and user convenience, allowing the worklight 900 to be used in a variety of settings and applications.

Referring to FIGS. 9D, 9E, 9I, and 9J, the worklight 900 is shown with the charge cord 860 on the retractable charge cord assembly 850 in various states of extension. The charge cord 860 can be extended to different lengths and locked in place to meet various user needs as described in examples herein. The charge cord 860 can be designed to lock after every X number of spool turns as described in some examples herein, and to catch when it is pulled to its full length as described in other examples.

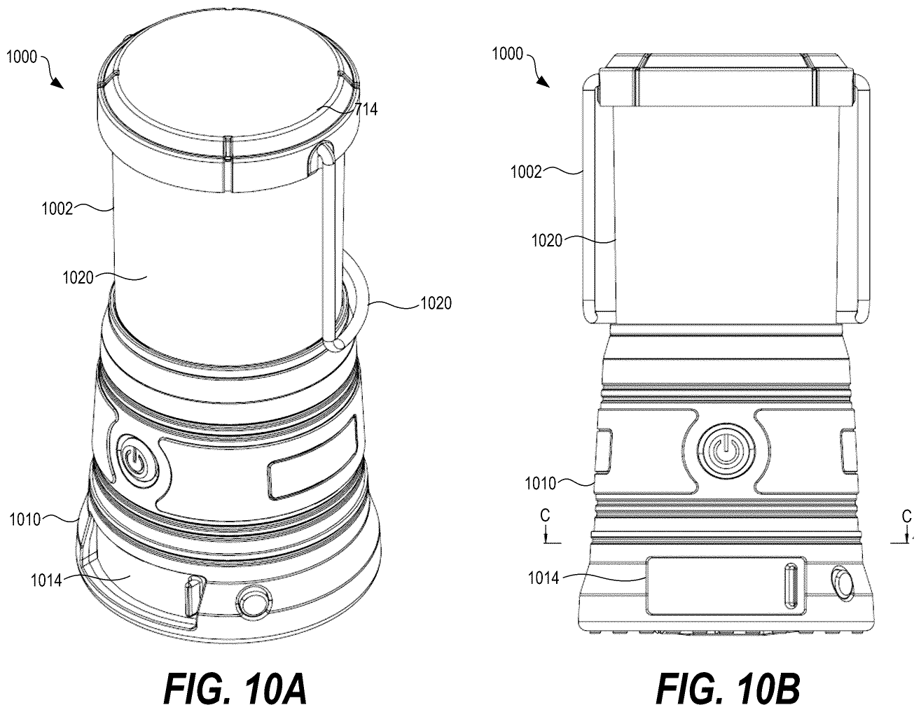

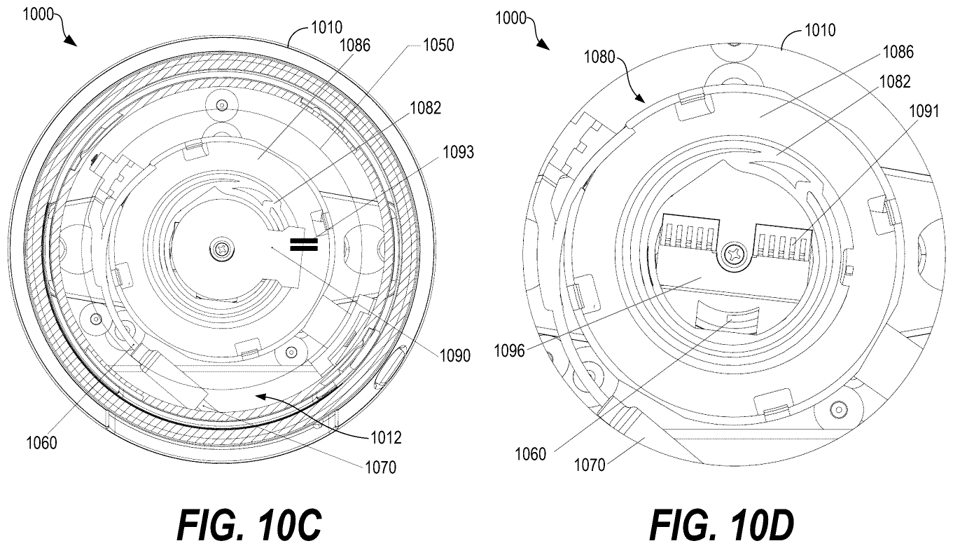

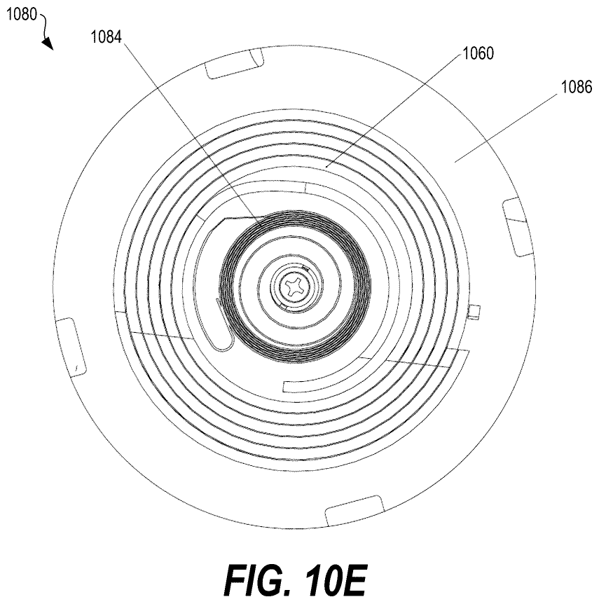

FIGS. 10A to 10E collectively illustrate different views of an example lighting device or lantern 1000 according to various aspects and embodiments of the present disclosure. In particular, FIGS. 10A and 10B illustrate a perspective and side view, respectively, of the lantern 1000 according to various aspects and embodiments of the present disclosure. FIG. 10C illustrates a cross-sectional top view of the lantern 1000 designated C-C in FIG. 10B according to various aspects and embodiments of the present disclosure. FIGS. 10D and 10E each illustrate another cross-sectional top view of the lantern 1000 designated C-C in FIG. 10B with certain components removed from view according to various aspects and embodiments of the present disclosure.

The lantern 1000 is illustrated as a representative example of a multi-functional, self-contained, and portable or hand-held lighting device that can function as both a light source and a power source for itself and other devices external to the lantern 1000. The concepts described herein can be extended to use with a range of lighting devices of different types, styles, components, and configurations, however. The lantern 1000 includes a power source such as a battery that can be coupled to and charged by a retractable charge cord assembly. The battery can then be used to power the lantern 1000 or another device external to the lantern 1000, thereby eliminating the need for separate charging cables or docking stations and providing significant advantages in convenience, portability, versatility, and utility compared to existing portable or rechargeable flashlights. These features and others described in examples herein allow the lantern 1000 to be suitable for use in a variety of challenging environments.

The lantern 1000 is not drawn to any particular scale or size in the drawings. The shape, size, proportion, and other characteristics of the lantern 1000 and the components thereof can vary as compared to that shown. For example, the lantern 1000 can accommodate different retractable charge cord assembly components, configurations, and locations, and other variations are within the scope of the examples described herein. Additionally, one or more of the parts or components of the lantern 1000, as illustrated in the drawings and described herein, can be omitted in some cases. The lantern 1000 can also include other parts or components that are not illustrated.

Among other components, the lantern 1000 shown in FIGS. 10A-10E includes a housing 1010, which can be constructed from a variety of materials, such as plastic, metal, or a combination thereof. The housing 1010 can be designed to be durable and resistant to environmental factors such as water, dust, and impacts. Within the housing 1010, a light source 1020 is disposed in the example shown. The light source 1020 can be any suitable type of light-emitting element, such as an LED, an incandescent bulb, or a halogen bulb, among others. The light source 1020 can be configured to emit light when powered, providing illumination for a user of the lantern 1000.

The lantern 1000 further includes a retractable charge cord assembly 1050, a stationary circuit board 1090, a power source or battery 1092, an internal power management system 1094, and a rotating circuit board 1096 disposed within the housing 1010 and electrically coupled to the light source 1020 in the example shown. The power source 1092 can be a rechargeable battery or a set of batteries that provide power to the lantern 1000. The power source or battery 1092 can be electrically coupled to the retractable charge cord assembly 1050, which can be at least partly integrated with the housing 1010 such as onto an external portion or into an internal portion of the housing 1010 in various examples. The retractable charge cord assembly 1050 in the example shown is at least partly integrated within the housing 1010.

The retractable charge cord assembly 1050 in the example shown is an example alternative embodiment of the retractable charge cord assembly 650 described herein and illustrated in FIGS. 6A-6D. For instance, the retractable charge cord assembly 1050 can include and implement one or more of the same or similar components, structure, attributes, features, or functions of the retractable charge cord assembly 650 described herein with reference to FIGS. 6A-6D.

The retractable charge cord assembly 1050 includes a charge cord 1060, a connector 1070 coupled to an end of the charge cord 1060, and a retraction mechanism 1080 configured to extend and retract the charge cord 1060. The retraction mechanism 1080 can be located at a convenient location on the lantern 1000, such as an upper side away from a base 1002 as shown in this example to provide easy access for a user. However, other locations on the lantern 1000 can be employed. The retractable charge cord assembly 1050 allows the lantern 1000 to be charged from an external power source, and in some cases, can also allow the lantern 1000 to serve as a power source for charging other devices as described in other examples herein.

The connector 1070 at the end of the charge cord 1060 can be configured to nest on or within a portion of the housing 1010 when the charge cord 1060 is fully retracted. This nesting feature can help protect the connector 1070 from damage and can also provide a neat and tidy appearance for the lantern 1000. The connector 1070 can be designed to fit snugly within a recess or cavity 1012 in the housing 1010, preventing it from protruding or dangling when not in use. The nesting feature can also prevent the connector 1070 from interfering with the operation of the lantern 1000 or becoming entangled with other objects.

The lantern 1000 can further include a cover 1014 movably coupled to the housing 1010. The cover 1014 can be designed to conceal the connector 1070 when in a closed position. The cover 1014 can be a separate component that is attached to the housing 1010, or it can be an integral part of the housing 1010 that can be manipulated to reveal or conceal the connector 1070. The cover 1014 can be designed to move in various ways, such as sliding, pivoting, or rotating, to reveal the connector 1070. The cover 1014 can be embodied as or otherwise include a latch, a catch, or another type of locking mechanism that secures it in a closed position, helping to protect the connector 1070 and charge cord 1060 from environmental factors.

The retraction mechanism 1080 can include a wheel or spool 1082 around which the charge cord 1060 is wound in the example shown. The wheel or spool 1082 can be circular in shape in this example and can be designed to rotate or spin, facilitating the extension and retraction of the charge cord 1060. The wheel or spool 1082 can be housed within a compartment or casing 1086 within the housing 1010 of the lantern 1000, providing protection and containment for the charge cord 1060 when it is not in use.

The spring mechanism 1084 can be configured to apply a force or tension to the wheel or spool 1082, causing it to spin or rotate in a direction that retracts the charge cord 1060. This automatic retraction feature can provide convenience for a user and can help to keep the charge cord 1060 neatly stored within the housing 1010 of the lantern 1000 when not in use. The charge cord 1060 can be designed to lock at different extension lengths in some examples. This feature can be implemented through various mechanical means, such as notches, detents, or ratchet-like mechanisms that can be integrated into the retraction mechanism 1080 in some cases. These locking features can provide a secure and reliable way to maintain the charge cord 1060 at a desired extension length, while also allowing for easy adjustment when needed.

One or both of the stationary circuit board 1090 or the rotating circuit board 1096 in the example shown can be at least partly embodied as or include at least one of a PCB, a microcontroller, an ASIC, or another type of circuit board. The power source or battery 1092 can be positioned within the housing 1010 and coupled to the retractable charge cord assembly 1050 at least in part by way of the stationary circuit board 1090 in the example shown. For instance, the retractable charge cord assembly 1050 can be coupled to the stationary circuit board 1090 and the stationary circuit board 1090 can include or be coupled to the power source or battery 1092.

The retractable charge cord assembly 1050 can further include a power transfer pathway that allows power to flow from an external power source (not illustrated), through the charge cord 1060, to the power source or battery 1092 in the work light 1000. This power transfer pathway can be facilitated by electrical connections or conductive materials within the charge cord 1060 and the lantern 1000. The power transfer pathway can allow the lantern 1000 to be charged from an external power source, such as a wall outlet or a USB port on a computer or other electronic device.

The power transmission path within the lantern 1000 can be designed to efficiently transmit power between the charge cord 1060, the rotating circuit board 1096, the stationary circuit board 1090, and the power source or battery 1092 in the lantern 1000. The charge cord 1060 can be electrically coupled to the stationary circuit board 1090, allowing power to flow from an external power source, through the charge cord 1060, to the stationary circuit board 1090. The stationary circuit board 1090 can include various electronic components and circuitry designed to regulate and control power flow within the lantern 1000. For instance, the stationary circuit board 1090 can include voltage regulators, current limiters, or charge controllers that can condition the incoming power from the charge cord 1060 to ensure safe and efficient charging of the power source or battery 1092. From the stationary circuit board 1090, the regulated power can be directed to the power source or battery 1092 through additional conductive pathways. These pathways can include traces on the stationary circuit board 1090 itself, as well as wires or other conductive elements that connect the stationary circuit board 1090 to battery terminals on the power source or battery 1092. In some embodiments, the stationary circuit board 1090 can include and implement sensing circuits that can monitor a battery's charge state and adjust charging parameters accordingly.

The stationary circuit board 1090 can also manage power output when the lantern 1000 is used to charge external devices. For instance, the stationary circuit board 1090 can include circuitry that allows power to flow from the power source or battery 1092, through the stationary circuit board 1090, and out through the charge cord 1060 to an external device. This feature can allow the lantern 1000 to serve as a power bank, providing a convenient power source for charging other electronic devices such as mobile phones, tablets, or other portable lighting devices. The stationary circuit board 1090 can further include protective circuitry in some cases designed to prevent damage to the lantern 1000 and connected devices. For instance, the stationary circuit board 1090 can include overvoltage protection circuits that prevent excessive voltage from damaging the power source or battery 1092 and the light source 1020. Similarly, the stationary circuit board 1090 can include short-circuit protection circuits that can prevent damage in the event of a short circuit in the charge cord 1060 and a connected device. The lantern 1000 can also include a switch (not shown) or other control mechanism in some examples that allows a user to select whether to charge the power source or battery 1092 or an external device. This switch can be physically located on the housing 1010 of the lantern 1000, or it can be an electronic switch controlled by the stationary circuit board 1090. The stationary circuit board 1090 can further include circuitry in some examples that detects the switch position and directs power flow accordingly.

The retractable charge cord assembly 1050 can also be designed to allow power to flow in an opposite direction out of the lantern 1000, from the power source or battery 1092, through the charge cord 1060, to an external device. This feature can allow the lantern 1000 to serve as a power source or power bank for charging other electronic devices, such as mobile phones, tablets, or other portable lighting devices. The direction of power flow can be controlled in some cases at least in part by way of a switch, a controller, or other control mechanism that can be positioned within the lantern 1000.

The power transfer from the charge cord 1060 to the rotating circuit board 1096, then to the stationary circuit board 1090, and subsequently to the power source or battery 1092 in the lantern 1000 for charging can be accomplished in some cases through a series of electrical connections and components. The charge cord 1060 can be embodied at least in part as or include conductive wires that can carry electrical current from an external power source. These wires in the charge cord 1060 can terminate at contact points on the rotating circuit board 1096 within the housing 1010. For instance, in some cases the wires in the charge cord 1060 can terminate at leaf-spring connectors 1091 on the rotating circuit board 1096 that maintain electrical connection or coupling of the stationary circuit board 1090 and the rotating circuit board 1096.

The stationary circuit board 1090 can serve as a central hub for power management within the lantern 1000 at least in part by way of the internal power management system 1094 in some examples. For instance, the stationary circuit board 1090 can include power regulation components such as at least one of voltage regulators, current limiters, or charge controllers in some cases. The internal power management system 1094 can use such components to ensure incoming power is appropriately conditioned for charging the power source or battery 1092.

When power flows from the charge cord 1060 to the stationary circuit board 1090 in some cases, it can first pass through protective circuitry designed to prevent damage from voltage spikes or reverse polarity. The stationary circuit board 1090 can process and regulate such incoming power in some examples. The stationary circuit board 1090 in some cases can include a dedicated charging integrated circuit (IC) that can manage the charging process while monitoring factors such as voltage, current, and temperature to optimize battery charging and protect against overcharging of the power source or battery 1092 or an external power source.

From the stationary circuit board 1090, the regulated power can be directed to the power source or battery 1092 through additional conductive pathways such as wires 1093 in some examples. The wires 1093 can be at least partly embodied as or include traces formed on the stationary circuit board 1090 itself, as well as wires or other conductive elements that connect the stationary circuit board 1090 to terminals on the power source or battery 1092. In some embodiments, the stationary circuit board 1090 can include sensing circuits that can be used by the internal power management system 1094 to monitor battery charge state and adjust charging parameters accordingly.

The stationary circuit board 1090 in some examples can further include one or more additional components, circuitry, circuit boards, or functionality related to power management. For instance, the stationary circuit board 1090 can be embodied such that the internal power management system 1094 can control power distribution to other components on or in the lantern 1000, such as the light source 1020 or any additional features like display screens or secondary lighting elements in some cases. The stationary circuit board 1090 can also be embodied such that the internal power management system 1094 can manage power output when the lantern 1000 is used as a power bank to charge external devices.

By centralizing power management through the stationary circuit board 1090 and the internal power management system 1094, the lantern 1000 design can achieve efficient and controlled charging of the power source or battery 1092 or an external power source while also enabling additional features and protections. This arrangement can allow for a compact and integrated power system within the constraints of the lantern's 1000 form factor.

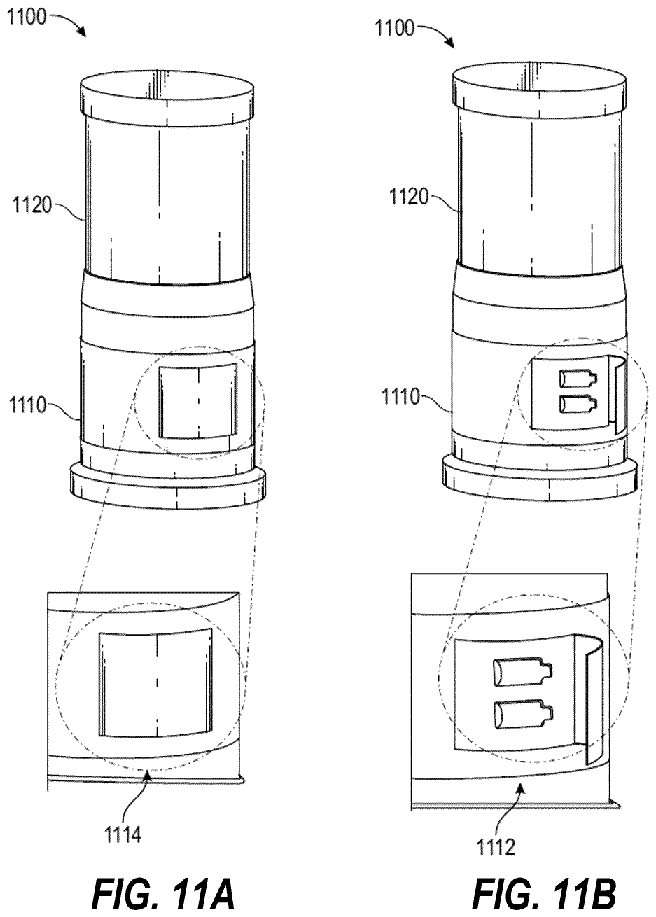

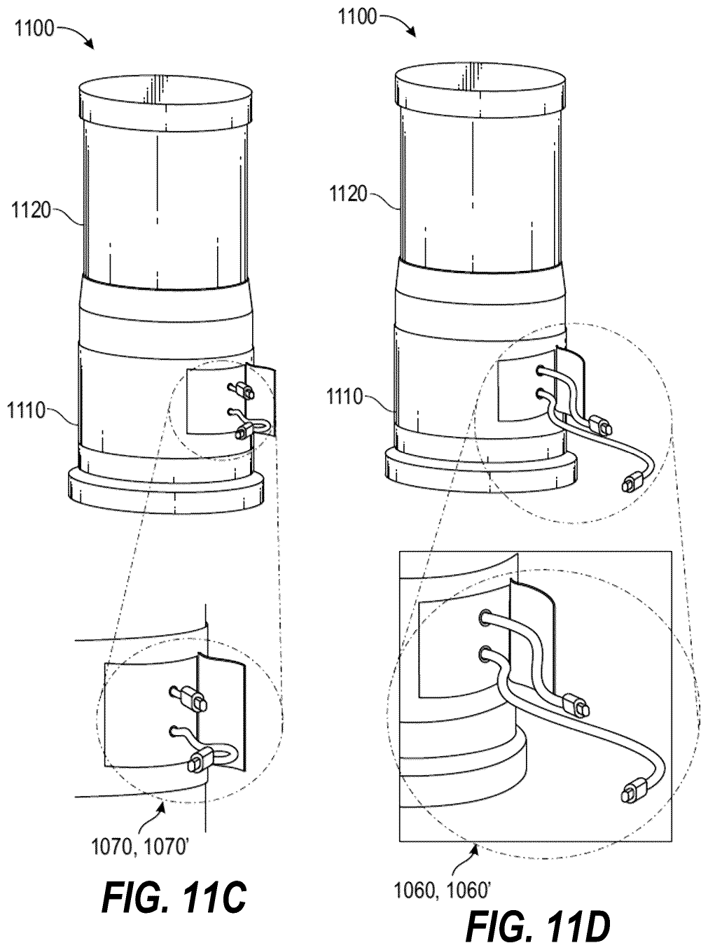

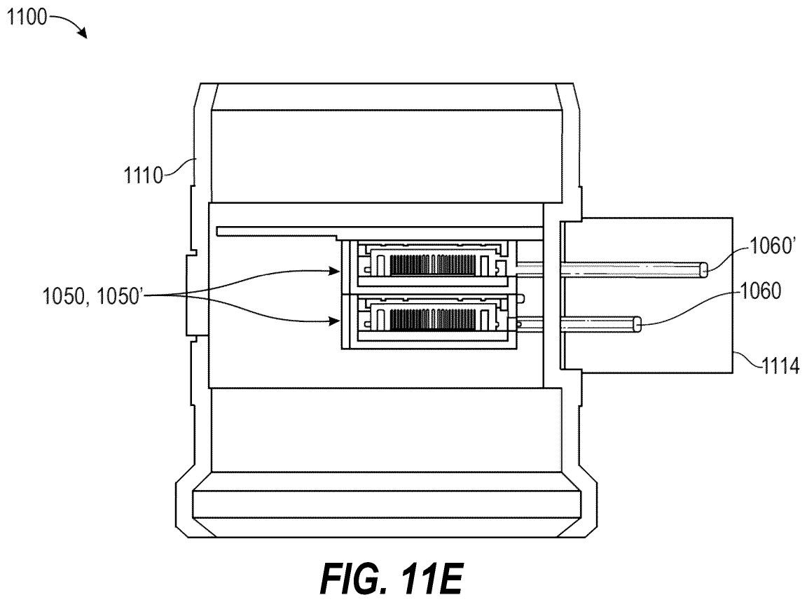

FIGS. 11A to 11F collectively illustrate different views of another example lighting device or lantern 1100 according to various aspects and embodiments of the present disclosure. In particular, FIGS. 11A, 11B, 11C, and 11D each illustrate a different perspective view of the lantern 1100 according to various aspects and embodiments of the present disclosure. In FIGS. 11B, 11C, and 11D, a cover component on the lantern 1100 shown in FIG. 11A is configured in an open position to illustrate another example nesting location of an example connector and charge cord according to one embodiment. FIG. 11E illustrates a cross-sectional front view of the lantern 1100 according to various aspects and embodiments of the present disclosure.

The lantern 1100 is an example alternative embodiment of the lantern 1000 described herein and illustrated in FIGS. 10A-10E. For instance, the lantern 1100 can include and implement one or more of the same or similar components, structure, attributes, features, or functions of the lantern 1000 described herein with reference to FIGS. 10A-10E. The lantern 1100 is illustrated as another representative example of a multi-functional, self-contained, and portable lighting device that can function as a power source for its own lighting source and other devices external to the lantern 1100.

The lantern 1100 is not drawn to any particular scale or size in the drawings. The shape, size, proportion, and other characteristics of the lantern 1100 and the components thereof can vary as compared to that shown. For example, the lantern 1100 can accommodate different retractable charge cord assembly components, configurations, and locations, and other variations are within the scope of the examples described herein. Additionally, one or more of the parts or components of the lantern 1100, as illustrated in the drawings and described herein, can be omitted in some cases. The lantern 1100 can also include other parts or components that are not illustrated.

Among other components, the lantern 1100 shown in FIGS. 11A-11E includes a housing 1110, which can be constructed from a variety of materials, such as plastic, metal, or a combination thereof. The housing 1110 can be designed to be durable and resistant to environmental factors such as water, dust, and impacts. Within the housing 1110, a light source 1120 is disposed in the example shown. The light source 1120 can be any suitable type of light-emitting element, such as an LED, an incandescent bulb, or a halogen bulb, among others. The light source 1120 can be configured to emit light when powered, providing illumination for a user of the lantern 1100.

The lantern 1100 further includes two of the retractable charge cord assemblies 1050, 1050′, two of the charge cords 1060, 1060′, two of the connectors 1070, 1070′, and two of the retraction mechanisms 1080, 1080′ integrated in the housing 1110 of the lantern 1100 in the example shown. The connectors 1070, 1070′ at the end of the charge cord 1060, 1060′, respectively, can both be configured to nest on or within a portion of the housing 1110 when the charge cords 1060, 1060′ are fully retracted. The connectors 1070, 1070′ can be designed to fit snugly within a recess or cavity 1112 in the housing 1110, preventing it from protruding or dangling when not in use.

The lantern 1100 can further include a cover 1114 movably coupled to the housing 1110. The cover 1114 can be designed to conceal the connectors 1070, 1070′ when in a closed position. The cover 1114 can be a separate component that is attached to the housing 1110, or it can be an integral part of the housing 1110 that can be manipulated to reveal or conceal the connectors 1070, 1070′. The cover 1114 can be designed to move in various ways, such as sliding, pivoting, or rotating, to reveal the connectors 1070, 1070′. The cover 1114 can be embodied as or otherwise include a latch, a catch, or another type of locking mechanism that secures it in a closed position, helping to protect the connectors 1070, 1070′ and charge cords 1060, 1060′ from environmental factors.

The retraction mechanisms 1080, 1080′ can include two of the wheels or spools 1082, 1082′ around which their corresponding charge cord 1060, 1060 can be wound in the example shown.

The retractable charge cord assemblies 1050, 1050′ can be strategically positioned around the housing 1100, potentially on different sides or sections of the lantern 1100. In operation, each retractable charge cord assembly 1050, 1050′ can function independently. Starting from a closed position where the cover 1114 conceals the charge cords 1060, 1060′, a user can open the cover 1114 to reveal the nested charge cords 1060, 1060′. The charge cords 1060, 1060′ can then be extended to various lengths, with each cord capable of locking into place at different extension points.

The lantern 1100 can enable users to extend multiple charge cords 1060, 1060′ simultaneously, potentially allowing for charging of the lantern 1100 from one cord while providing power to external devices through other cords. When not in use, the charge cords 1060, 1060′ can be retracted back into their respective nesting areas within the housing 1100, maintaining a neat and compact appearance. This multi-cord configuration can enhance the versatility and functionality of the lantern 1100, allowing it to serve as both a lighting device and a multi-port charging hub.

In one example, one charge cord 1060, 1060′ can be extended and connected to an external power source to at least one of charge the lantern's power source or directly power the light source 1120, while another charge cord (e.g., the other charge cord 1060, 1060′) can be extended and connected to an external device to charge that device. This multi-cord configuration can enhance the versatility and functionality of the lantern 1100, allowing it to concurrently serve as both a lighting device and a charging hub.

In some cases, each retractable charge cord assembly 1050, 1050′ can include its own retraction mechanism 1080, 1080′. These retraction mechanisms 1080, 1080′ can be designed to operate independently, allowing each charge cord 1060, 1060′ to be extended, and retracted separately. This feature can provide flexibility for a user, allowing them to adjust the length of each charge cord 1060, 1060′ based on their specific charging needs or the location of power sources. The retraction mechanisms 1080, 1080′ can include features such as the wheels or spools 1082, 1082′ around which the charge cords 1060, 1060′ can be wound, and two of the spring mechanism 1084, 1084′ that facilitate automatic retraction of the respective charge cord 1060, 1060′ when not in use.

The charge cord (e.g., the charge cord 160, 360, 660, 760, 1060) of the various embodiments described herein can have various geometries to enhance its functionality and ease of use. The charge cord can be designed with a thin and flat profile, which can allow for more efficient storage within the retraction mechanism. This flat design can enable a longer cord length to be stored in a compact space, potentially increasing the reach of the charging cord without significantly increasing the size of the device. Thus, the charge cord can have a ribbon-like structure, with a width greater than its thickness. The wider profile can also distribute stress more evenly across the cord, potentially increasing its durability and lifespan.

The charge cord (e.g., the charge cord 160, 360, 660, 760, 1060) can also be designed with a variable cross-section along its length. For instance, the cord can be thicker near the connector end for added durability, and gradually become thinner towards the retraction mechanism. This tapered design can facilitate smoother retraction and reduce wear on the cord over time. In some implementations, the charge cord can feature a textured surface. This texture can provide improved grip for the user when extending or retracting the cord. The textured surface can also help reduce friction against other surfaces, potentially decreasing the likelihood of the cord becoming caught or tangled during use. The charge cord can also incorporate flexible yet durable materials that allow it to bend and flex without breaking. This flexibility can enable the cord to be stored more compactly within the retraction mechanism and can also enhance its ability to navigate around obstacles when extended.

The features, structures, or characteristics described above may be combined in one or more embodiments in any suitable manner, and the features discussed in the various embodiments are interchangeable, if possible. In the above description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,”“coplanar,”and other terms.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable. Further, if a component is described as there being “at least one” of said component, it is understood that this may mean “one or more” of said component. Conversely, if a component is described as there being “one or more” of said component, it is understood that this may mean “at least one”of said component.

As referenced herein in the context of quantity, the terms “a” or “an” are intended to mean “at least one” and are not intended to imply “one and only one.” As referred to herein, the terms “include,” “includes,” and “including” are each intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, fluid coupling, thermal coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. A lighting device, comprising:
a housing;
a light source disposed within the housing;
a power source disposed within the housing and electrically coupled to the light source; and
a retractable charge cord assembly integrated with the housing, the retractable charge cord assembly comprising:
a charge cord;
a connector coupled to an end of the charge cord; and
a retraction mechanism configured to extend and retract the charge cord.

2. The lighting device of claim 1, wherein the retraction mechanism comprises a wheel around which the charge cord is wound.

3. The lighting device of claim 2, wherein the retraction mechanism further comprises a spring mechanism coupled to the wheel to facilitate automatic retraction of the charge cord.

4. The lighting device of claim 1, wherein the connector is configured to nest on or within a portion of the housing when the charge cord is fully retracted.

5. The lighting device of claim 1, further comprising a cover movably coupled to the housing, the cover configured to conceal the connector when in a closed position.

6. The lighting device of claim 1, wherein the charge cord is configured to lock at one or more extension lengths.

7. The lighting device of claim 1, further comprising a printed circuit board disposed within the housing and electrically coupled to the power source and the retractable charge cord assembly.

8. The lighting device of claim 7, wherein the printed circuit board is configured to manage power transfer between the retractable charge cord assembly and the power source.

9. The lighting device of claim 1, wherein the lighting device is configured to receive power through the retractable charge cord assembly to at least one of charge the power source or power the light source and to provide power to an external device through the retractable charge cord assembly.

10. The lighting device of claim 1, wherein the lighting device is selected from the group consisting of a flashlight, a headlamp, a headlamp battery pack, a lantern, and a worklight.

11. A flashlight, comprising:
a housing having a front end and a rear end opposite the front end;
a light source disposed at the front end of the housing;
a power source disposed within the housing and electrically coupled to the light source; and
a retractable charge cord assembly integrated with the housing, the retractable charge cord assembly comprising:
a charge cord;
a connector coupled to an end of the charge cord; and
a retraction mechanism configured to extend and retract the charge cord.

12. The flashlight of claim 11, wherein the retractable charge cord assembly is disposed at the rear end of the housing.

13. The flashlight of claim 11, further comprising a tailcap at the rear end of the housing, wherein the tailcap is movable relative to the housing to reveal the connector.

14. The flashlight of claim 11, wherein the retraction mechanism comprises a wheel around which the charge cord is wound and a spring mechanism coupled to the wheel to facilitate automatic retraction of the charge cord.

15. The flashlight of claim 11, wherein the charge cord is configured to lock at one or more extension lengths.

16. The flashlight of claim 11, wherein the connector is configured to nest on or within a portion of the housing when the charge cord is fully retracted.

17. A headlamp, comprising:
a housing;
a light source disposed within the housing;
a power source disposed within the housing and electrically coupled to the light source; and
a retractable charge cord assembly integrated with the housing, the retractable charge cord assembly comprising:
a charge cord;
a connector coupled to an end of the charge cord; and
a retraction mechanism configured to extend and retract the charge cord.

18. The headlamp of claim 17, wherein the retraction mechanism comprises a wheel around which the charge cord is wound.

19. The headlamp of claim 18, wherein the retraction mechanism further comprises a spring mechanism coupled to the wheel to facilitate automatic retraction of the charge cord.

20. The headlamp of claim 17, further comprising:
a strap coupled to the housing for securing the headlamp to a user's head; and
a cover movably coupled to the housing, the cover configured to conceal the connector when in a closed position.

21. The headlamp of claim 17, wherein the headlamp is configured to receive power through the retractable charge cord assembly to at least one of charge the power source or power the light source and to provide power to an external device through the retractable charge cord assembly.

22. A headlamp battery pack, comprising:
a housing;
a power source disposed within the housing; and
a retractable charge cord assembly integrated with the housing, the retractable charge cord assembly comprising:
a charge cord;
a connector coupled to an end of the charge cord; and
a retraction mechanism configured to extend and retract the charge cord.

23. The headlamp battery pack of claim 22, wherein the retraction mechanism comprises a wheel around which the charge cord is wound and a spring mechanism coupled to the wheel to facilitate automatic retraction of the charge cord.

24. The headlamp battery pack of claim 22, wherein the connector is configured to nest on or within a portion of the housing when the charge cord is fully retracted.

25. The headlamp battery pack of claim 22, further comprising:
a strap attachment mechanism for coupling the headlamp battery pack to a headlamp strap; and
a cover movably coupled to the housing, the cover configured to conceal the connector when in a closed position.

26. The headlamp battery pack of claim 22, wherein the charge cord is configured to lock at one or more extension lengths.

27. A lantern, comprising:
a housing;
a light source disposed within the housing;
a power source disposed within the housing and electrically coupled to the light source; and
a retractable charge cord assembly integrated with the housing, the retractable charge cord assembly comprising:
a charge cord;
a connector coupled to an end of the charge cord; and
a retraction mechanism configured to extend and retract the charge cord.

28. The lantern of claim 27, wherein the retraction mechanism comprises a wheel around which the charge cord is wound.

29. The lantern of claim 28, wherein the retraction mechanism further comprises a spring mechanism coupled to the wheel to facilitate automatic retraction of the charge cord.

30. The lantern of claim 27, further comprising a cover movably coupled to the housing, the cover configured to conceal the connector when in a closed position.

31. The lantern of claim 27, wherein the lantern is configured to receive power through the retractable charge cord assembly to at least one of charge the power source or power the light source and to provide power to an external device through the retractable charge cord assembly.

32. The lantern of claim 27, wherein the connector is configured to nest on or within a portion of the housing when the charge cord is fully retracted.

33. A worklight, comprising:
a housing;
a light source disposed within the housing;
a power source disposed within the housing and electrically coupled to the light source; and
a retractable charge cord assembly integrated with the housing, the retractable charge cord assembly comprising:
a charge cord;
a connector coupled to an end of the charge cord; and
a retraction mechanism configured to extend and retract the charge cord.

34. The worklight of claim 33, wherein the retraction mechanism comprises a wheel around which the charge cord is wound.

35. The worklight of claim 34, wherein the retraction mechanism further comprises a spring mechanism coupled to the wheel to facilitate automatic retraction of the charge cord.

36. The worklight of claim 33, wherein the connector is configured to nest on or within a portion of the housing when the charge cord is fully retracted.

37. The worklight of claim 33, wherein the charge cord is configured to lock at one or more extension lengths.

38. The worklight of claim 33, wherein the worklight is configured to receive power through the retractable charge cord assembly to at least one of charge the power source or power the light source and to provide power to an external device through the retractable charge cord assembly.
